(19) United States
(12) Patent Application Publication
(10) Pub. No.: US 2026/0320006 A1
(43) Pub. Date: Oct. 15, 2026

(54) CONTAINER GENERATION BASED ON COMPRESSED FILES

(71) Applicant: International Business Machines Corporation, Armonk, NY (US)

(72) Inventors: QIN YUE CHEN, Shanghai (CN); Yu Zhuo Sun, BEIJING (CN); Chao Jun Wei, BEIJING (CN)

(21) Appl. No.: 19/173,887

(22) Filed: Apr. 9, 2025

(51) Int. Cl. G06F 16/188; G06F 16/11; G06F 16/13

(52) U.S. Cl. CPC G06F 16/192; G06F 16/128; G06F 16/13

(57) ABSTRACT

Generation of containers based on the compressed files includes receiving container data associated with a first container. The first container includes layers and each layer stores compressed files. Mapping data associated with each layer of the layers is generated based on the container data. The mapping data indicates mappings. Each mapping maps file path data for each compressed file to file data associated with a corresponding compressed file. Indexing data based on the mapping data is generated. The indexing data indicates an index of the mapping data of each layer into a merged view layer. A second container is generated based on the indexing data. The second container includes at least one image associated with each layer and the merged view layer. The second container is different from the first container. The second container is output.

### BACKGROUND

The disclosure relates to the containerization and more particularly, to the generation of new containers.

In recent years, the adoption of containerized applications has grown exponentially due to their ability to package software with entire dependencies for deployment across diverse environments. The containers provide lightweight, portable, and efficient solutions for software deployment, making them integral to modern cloud-native architectures. Container images serve as foundational building blocks of the containers composed of multiple layers. The multiple layers represent incremental changes to the filesystem and are stacked together to form a complete image. By utilizing containers, developers can ensure that their applications run consistently across various environments. Container Platforms orchestrate the containers, automating their deployment and scaling across diverse environments.

### SUMMARY

The following summary is provided to facilitate an understanding of some of the innovative features unique to the present disclosure and is not intended to be a full description. A full appreciation of the present disclosure may be gained by taking the entire specification, claims, drawings, and abstract as a whole.

In various embodiments of the disclosure, a computer-implemented method for generation of a second container based on container data of a first container is described. The computer-implemented method includes receiving, by the computer, container data associated with a first container. The first container includes one or more layers. Each layer of the one or more layers stores one or more compressed files. The computer-implemented method includes generating, by the computer, data mapping associated with each layer of the one or more layers based on the container data. The mapping data indicates one or more mappings between file path data for each compressed file of the one or more compressed files and file data associated with a corresponding compressed file of the one or more compressed files. The computer-implemented method includes generating, by the computer, indexing data based on the mapping data. The indexing data indicates an indexing of the mapping data of each layer of the one or more layers into a merged view layer. The computer-implemented method includes generating, by the computer, a second container based on the indexing data. The second container includes at least one image associated with each layer of the one or more layers and the merged view layer. The second container is different from the first container. The computer-implemented method includes outputting, by the computer, the second container.

In various embodiments of the disclosure, a computer system for generation of a second container based on container data of a first container is described.

In various embodiments of the disclosure, a computer program product for generation of a second container based on container data of a first container is described.

Additional technical features and benefits are realized through the techniques of the disclosure. Embodiments and aspects of the disclosure are described in detail herein and are considered a part of the claimed subject matter. For a better understanding, refer to the detailed description and the drawings.

### BRIEF DESCRIPTION OF THE DRAWINGS

The following description will provide details of preferred embodiments with reference to the following figures wherein:

FIG. 1 is a diagram that illustrates a computing environment for generation of a second container based on container data of a first container, in accordance with an embodiment of the disclosure;

FIG. 2 is a diagram that illustrates a network environment for the generation of the second container based on the container data of a first container, in accordance with an embodiment of the disclosure;

FIG. 3 is a diagram that illustrates one or more operations performed by a system for the generation of the second container based on the container data of the first container, in accordance with an embodiment of the disclosure;

FIG. 4A is a diagram that illustrates a schematic diagram of the second container, in accordance with an embodiment of the disclosure;

FIG. 4B is a diagram that illustrates a schematic diagram of an image layer of the second container, in accordance with an embodiment of the disclosure;

FIG. 5A is a diagram that illustrates a schematic diagram of a central directory associated with the second container, in accordance with an embodiment of the disclosure;

FIG. 5B is a diagram that illustrates a schematic diagram of mapping data associated with the second container, in accordance with an embodiment of the disclosure;

FIG. 6 is a diagram that illustrates one or more operations performed by the system for the addition of a file to a writable layer of the second container, in accordance with an embodiment of the disclosure;

FIG. 7 is a diagram that illustrates a flowchart of a method for updating a compressed file in the writable layer, in accordance with an embodiment of the disclosure;

FIG. 8 is a diagram that illustrates one or more operations performed by the system for updation of mapping data associated with the second container, in accordance with an embodiment of the disclosure; and

FIG. 9 is a diagram that illustrates a flowchart of an exemplary method for the generation of the second container based on the container data of a first container, in accordance with an embodiment of the disclosure.

### DETAILED DESCRIPTION

Containerized applications have become a foundation of modern software development, enabling scalability, portability, and management of application workloads. By encapsulating application code along with entire dependencies, containers ensure consistent operation across various environments. This encapsulation allows developers to focus on building features rather than troubleshooting environment discrepancies.

Container platforms orchestrate the containers, automating the deployment, scaling, and management across diverse environments. Container platforms provides a framework for managing containerized applications, enabling deployment strategies that may adapt to changing workloads. This orchestration enables communication and scaling in response to users demanding multiple containers.

However, as applications grow in complexity and size, challenges arise, particularly concerning load speed of container images and memory consumption. Large container images may lead to slower load times, impacting on the overall performance and responsiveness of applications. To this end, reduced load speed and high memory consumption are especially undesired in environments where rapid scaling is vital to meet fluctuating user demands. Additionally, memory footprints of the container images may increase significantly due to the accumulation of dependencies and layers, leading to larger container image sizes, leading to resource inefficiencies, such as poor use of system resources, and potential bottlenecks in application performance.

When a new container utilizing a new image is deployed, conventional systems begin with downloading image layers from a repository, where each layer is typically downloaded separately. This approach may introduce network latency that often results in delays or increased time for deployment. Further, each layer's zip file may have to be decompressed to a disk. This is particularly problematic in environments where storage resources are limited and expensive, such as Non-Volatile Memory Express (NVMe) drives. The NVMe drives are favored for their high-speed performance, making them an attractive option for hosting container images. However, they come with a high cost and limited storage capacity. The act of decompressing each layer consumes disk space, and many files in lower layers may never be utilized, as they are overshadowed by the same files present in higher layers. This redundancy leads to inefficient use of storage resources due to the allocation of space for files that are effectively rendered obsolete by subsequent layers.

In addition to the storage concerns, conventional systems load an image layer from a repository into the new container, which may be time-consuming, particularly when multiple layers are to be loaded. Each layer must be decompressed, which adds to the overall time needed to start a new container. Furthermore, the overhead associated with compressing and decompressing layers can significantly slow down the deployment process. This delay may be detrimental in environments where rapid scaling and quick response times are desired, as the time taken to prepare the container may hinder the overall performance of applications.

To address the issue, embodiments of the present disclosure provide a system that utilizes archived layers, eliminating the need to decompress layer zip files into directories. This approach significantly conserves disk space and reduces startup time for new containers, addressing the challenges associated with load speed and memory consumption faced by conventional systems. By maintaining layers in their compressed state, the system minimizes the storage footprint allowing the system to leverage high-performance storage solutions like NVMe drives. This is particularly advantageous in environments where storage resources are limited and costly, as it reduces the amount of space consumed by redundant files that may never be accessed.

Moreover, by avoiding the decompression of layers, the system enhances input/output (I/O) performance. The traditional method of uncompressing layers can introduce latency and overhead, particularly when multiple layers are involved. In contrast, the system of the present disclosure allows for direct access to the compressed layers, streamlining the process of loading executables, shared libraries, and configuration files. This results in faster container startup times and improved overall application performance, making it ideal for dynamic environments that need rapid scaling and responsiveness.

The system reduces the complexity of file management within containers. This simplification leads to fewer file system operations, which enhances performance, especially in high-throughput scenarios. Additionally, the system supports efficient caching mechanisms, allowing access files by quickly retrieved without the need for decompression, further optimizing I/O performance.

Furthermore, the present disclosure provides improved resource utilization by allowing multiple containers to share the same compressed layers without duplicating data on disk. This duplication not only saves space but also reduces the time needed for updates and deployments, as changes can be made to the compressed layers without affecting the entire file system structure.

In various embodiments of the disclosure, a computer-implemented method for generating a second container based on container data of a first container is described. The computer-implemented method includes receiving, by the computer, container data associated with a first container. The first container includes one or more layers. Each layer of the one or more layers stores one or more compressed files. The computer-implemented method includes generating, by the computer, mapping data associated with each layer of the one or more layers based on the container data. The mapping data indicates one or more mappings and each mapping of the one or more mappings maps file path data for each compressed file of the one or more compressed files to file data associated with a corresponding compressed file of the one or more compressed files. The computer-implemented method includes generating, by the computer, indexing data based on the mapping data. The indexing data indicates an index of the mapping data of each layer of the one or more layers into a merged view layer. The computer-implemented method further includes generating, by the computer, a second container based on the indexing data. The second container includes at least one image associated with each layer of the one or more layers and the merged view layer. The second container is different from the first container. The computer-implemented method includes outputting, by the computer, the second container.

In various embodiments of the disclosure, the container data includes at least one of layer data associated with each layer of the one or more layers, file metadata associated with each compressed file of the one or more compressed files of each layer of the one or more layers, or file content data associated with each compressed file of the one or more compressed files.

In various embodiments of the disclosure, a specific layer of the one or more layers includes the one or more compressed files. The mapping data associated with the specific layer includes the one or more mappings, and each mapping of the one or more mappings is associated with a corresponding compressed file of the one or more compressed files.

In various embodiments of the disclosure, a specific compressed file of the one or more compressed files of the specific layer is associated with a specific mapping of the one or more mappings. The specific mapping includes a key indicating the file path data associated with the specific compressed file in the specific layer and a value indicating the file data associated with the specific compressed file.

In various embodiments of the disclosure, the file data of the specific compressed file includes at least one of a file name, content data, file header data, file header offset in the specific compressed file, or data length information associated with the specific compressed file in a corresponding layer of the one or more layers.

In various embodiments of the disclosure, the computer-implemented method further includes merging, by the computer, one or more values associated with the one or more mappings for the specific layer. The one or more values are merged based on one or more keys associated with the one or more mappings being associated with the specific layer. The one or more values are inclusive of the value of the specific compressed file and the one or more keys are inclusive of the key of the specific compressed file. The computer-implemented method further includes generating, by the computer, the index of the mapping data for the specific layer based on the merging. The computer-implemented method further includes generating, by the computer, the merged view layer based on the indexing of the mapping data for the specific layer.

In various embodiments of the disclosure, the computer-implemented method further includes generating, by the computer, at least one image for each layer of the one or more layers. The at least one image indicates the one or more compressed files for a corresponding layer of the one or more layers. The computer-implemented method further includes adding, by the computer, the at least one image for each layer of the one or more layers to the second container. The computer-implemented method further includes adding, by the computer, the merged view layer to the second container. The merged view layer is added above the at least one image for each layer of the one or more layers. The computer-implemented method further includes generating, by the computer, a writable layer for the second container. The computer-implemented method further includes adding, by the computer, the writable layer to the second container. The writable layer is added above the merged view layer.

In various embodiments of the disclosure, the computer-implemented method further includes receiving, by the computer, update data associated with a compressed file of the one or more compressed files. The computer-implemented method further includes determining, by the computer, a presence of the compressed file of the one or more compressed files in the writable layer. The computer-implemented method further includes updating, by the computer, the compressed file in the writable layer based on the update data.

In various embodiments of the disclosure, the computer-implemented method further includes receiving, by the computer, update data associated with a compressed file of the one or more compressed files. The computer-implemented method further includes determining, by the computer, an absence of the compressed file of the one or more compressed files in the writable layer. The computer-implemented method further includes retrieving, by the computer, the mapping data associated with the compressed file from the merged view layer. The mapping data is retrieved based on the determination of the absence. The computer-implemented method further includes adding, by the computer, the compressed file of the one or more compressed files in the writable layer based on the mapping data associated with the compressed file. The computer-implemented method further includes updating, by the computer, the compressed file in the writable layer based on the addition of the compressed file in the writable layer. The compressed file is updated based on the update data.

In various embodiments of the disclosure, adding the compressed file of the one or more compressed files in the writable layer further includes retrieving, by the computer, file content associated with the compressed file based on the file data associated with the compressed file. The computer-implemented method further includes adding, by the computer, the file content to the writable layer.

In various embodiments of the disclosure, the computer-implemented method further includes generating, by the computer, an updated layer for the second container. The updated layer is generated based on the updated compressed file. The computer-implemented method further includes adding, by the computer, the updated layer to the second container. The updated layer is added below the merged view layer. The computer-implemented method further includes updating, by the computer, the mapping data associated with the compressed file based on the update of the compressed file and the addition of the updated layer to the second container.

In various embodiments of the disclosure, the computer-implemented method further includes parsing, by the computer, the mapping data associated with each layer of the one or more layers. The computer-implemented method further includes determining, by the computer, dependency data associated with the one or more layers based on the parsing of the mapping data. The computer-implemented method further includes generating, by the computer, the indexing data based on the dependency data.

In various embodiments of the disclosure, a computer system for the generation of containers based on compressed files is described. The computer system includes a processor set, one or more computer-readable storage media, and program instructions that are stored on the one or more computer-readable storage media. The program instructions are executable by the processor set to cause the processor set to receive container data associated with a first container, The first container includes one or more layers. Each layer of the one or more layers stores one or more compressed files. The program instructions are executable by the processor set to cause the processor set to generate mapping data associated with each layer of the one or more layers based on the container data. The mapping data indicates one or more mappings, and each mapping of the one or more mappings includes a key indicating file path data associated with a corresponding compressed file of the one or more compressed files and a value indicating file data associated with the corresponding compressed file of the one or more compressed files. The program instructions are executable by the processor set to cause the processor set to generate indexing data based on the mapping data. The indexing data indicates an index of the mapping data of each layer of the one or more layers into a merged view layer. The program instructions are executable by the processor set to cause the processor set to generate a second container based on the indexing data. The second container includes at least one image associated with each layer of the one or more layers and the merged view layer. The second container is different from the first container. The program instructions are executable by the processor set to cause the processor set to output the second container.

In various embodiments of the disclosure, the program instructions further cause the processor set to merge one or more values associated with the one or more mappings for a specific layer. The one or more values are merged based on one or more keys associated with the one or more mappings being associated with the specific layer. The one or more values is inclusive of the value and the one or more keys are inclusive of the key. Further, the program instructions cause the processor set to generate the index of the mapping data for the specific layer based on the merging. Further, the program instructions cause the processor set to generate the merged view layer based on the index of the mapping data for the specific layer.

In various embodiments of the disclosure, the program instructions further cause the processor set to generate at least one image for each layer of the one or more layers. The at least one image indicates the one or more compressed files for a corresponding layer of the one or more layers. Further, the program instructions cause the processor set to add the at least one image for each layer of the one or more layers to the second container. Further, the program instructions cause the processor set to add the merged view layer to the second container. The merged view layer is added above the at least one image for each layer of the one or more layers. Further, the program instructions cause the processor set to generate a writable layer for the second container. Further, the program instructions cause the processor set to add the writable layer to the second container. The writable layer is added above the merged view layer.

In various embodiments of the disclosure, the program instructions further cause the processor set to receive update data associated with a compressed file of the one or more compressed files. Further, the program instructions cause the processor set to determine a presence of the compressed file of the one or more compressed files in the writable layer. Further, the program instructions cause the processor set to update the compressed file in the writable layer based on the update data.

In various embodiments of the disclosure, the program instructions further cause the processor set to receive update data associated with a compressed file of the one or more compressed files. Further, the program instructions cause the processor set to determine an absence of the compressed file of the one or more compressed files in the writable layer. Further, the program instructions cause the processor set to retrieve the mapping data associated with the compressed file from the merged view layer. The mapping data is retrieved based on the determination of the absence. Further, the program instructions cause the processor set to add the compressed file of the one or more compressed files in the writable layer based on the mapping data associated with the compressed file. Further, the program instructions cause the processor set to update the compressed file in the writable layer based on the addition of the compressed file in the writable layer. The compressed file is updated based on the update data.

In various embodiments of the disclosure, to add the compressed file of the one or more compressed files in the writable layer, the program instructions further cause the processor set to retrieve file content associated with the compressed file based on the file data associated with the compressed file. Further, the program instructions cause the processor set to add the file content to the writable layer.

In various embodiments of the disclosure, the program instructions further cause the processor set to generate an updated layer for the second container. The updated layer is generated based on the updated compressed file. Further, the program instructions cause the processor set to add the updated layer to the second container. The updated layer is added below the merged view layer. Further, the program instructions cause the processor set to update the mapping data associated with the compressed file based on the update of the compressed file and the addition of the updated layer to the second container.

In various embodiments of the disclosure, a computer program product for generation of containers based on compressed files is described. The computer program product includes a computer-readable storage medium having program instructions stored on the computer-readable storage media to perform operations. The operations include receiving container data associated with the first container. The first container includes one or more layers. Each layer of the one or more layers stores the one or more compressed files. The operations include generating mapping data associated with each layer of the one or more layers based on the container data. The mapping data indicates one or more mappings and each mapping of the one or mapping maps file path data for a compressed file of the one or more compressed files to file data associated with the compressed file of the one or more compressed file. The operation includes generating indexing data based on the mapping data. The indexing data indicates an index of the mapping data of each layer of the one or more layers into a merged view layer. The operation includes generating the second container based on the indexing data. The second container includes at least one image associated with each layer of the one or more layers and the merged view layer. The second container is different from the first container. The operation includes outputting the second container.

Various aspects of the present disclosure are described by narrative text, flowcharts, block diagrams of computer systems, and/or block diagrams of the machine logic included in computer program product CPP embodiments. With respect to any flowcharts, depending upon the technology involved, the operations may be performed in a different order than what is shown in each flowchart. For example, again depending upon the technology involved, two operations shown in successive flowchart blocks may be performed in reverse order, as a single integrated operation, concurrently, or in a manner at least partially overlapping in time.

A computer program product embodiment “CPP embodiment” or “CPP” is a term used in the present disclosure to describe any set of one, or more, storage media also called “mediums” collectively included in a set of one, or more, storage devices that collectively include machine readable code corresponding to instructions and/or data for performing computer operations specified in a given CPP claim. A “storage device” is any tangible device that may retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory RAM, read-only memory ROM, erasable programmable read-only memory EPROM or Flash memory, static random-access memory SRAM, compact disc read-only memory CD-ROM, digital versatile disk DVD, memory stick, floppy disk, mechanically encoded device such as punch cards or pits/lands formed in a major surface of a disc or any suitable combination of the foregoing. A computer-readable storage medium, as that term is used in the present disclosure, is not to be construed as storage in the form of transitory signals per se, such as radio waves or freely propagating electromagnetic waves, electromagnetic waves propagating through a waveguide, light pulses passing through a fiber optic cable, electrical signals communicated through a wire, and/or transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

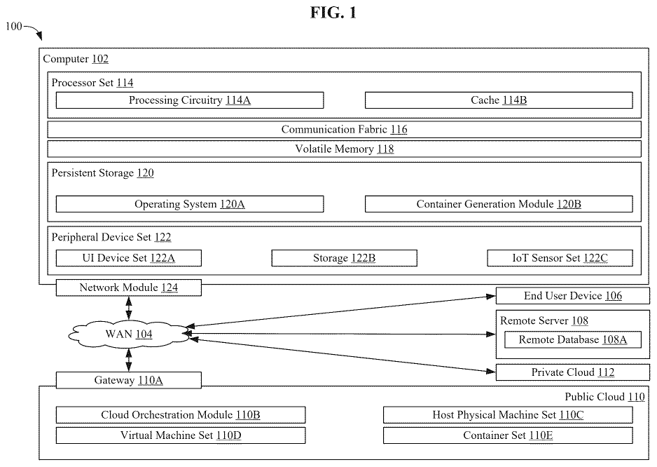

FIG. 1 is a diagram that illustrates a computing environment for generation of a second container based on container data of a first container, in accordance with an embodiment of the disclosure. With reference to FIG. 1, there is shown a computing environment 100 that contains an example of an environment for the execution of at least some of the computer code involved in performing the disclosed methods, such as a container generation module 120B. In addition to the container generation module 120B, computing environment 100 includes, for example, a computer 102, a wide area network WAN 104, an end user device EUD 106, a remote server 108, a public cloud 110, and a private cloud 112. In this embodiment of the disclosure, the computer 102 includes a processor set 114 including a processing circuitry 114A and a cache 114B, a communication fabric 116, a volatile memory 118, a persistent storage 120 including an operating system 120A and the container generation module 120B, as identified above, a peripheral device set 122 including a user interface UI device set 122A, a storage 122B, and an Internet of Things IoT sensor set 122C, and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or wearable computer, a mainframe computer, a quantum computer, or any form of a computer or a mobile device now known or to be developed in the future that is run a program, accessing a network or querying a database, such as a remote database 108A. As is well understood in the art of computer technology, and depending upon the technology, the performance of a computer-implemented method may be distributed among multiple computers and/or between multiple locations. In an embodiment, in this presentation of the computing environment 100, detailed discussion is focused on a single computer, specifically the computer 102, to keep the presentation as simple as possible. The computer 102 may be located in a cloud, even though it is not shown in a cloud in FIG. 1. The computer 102 is not needed to be in a cloud except to any extent as is affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B is a memory that is located in the processor chip packages and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby affect a computer-implemented method, such that the instructions thus executed will instantiate the methods specified in flowcharts and/or narrative descriptions of computer-implemented methods included in this document collectively referred to as “the disclosed methods”. These computer-readable program instructions are stored in various types of computer-readable storage media, such as the cache 114B and the storage media discussed below. The program instructions, and associated data, are accessed by the processor set 114 to control and direct the performance of the disclosed methods. In computing environment 100, at least some of the instructions for performing the disclosed methods may be stored in the dynamic modification of the container generation module 120B in persistent storage 120.

Communication fabric 116 is the signal conduction path that allows the various components of computer 102 to interact and exchange information. Typically, this fabric is made of switches and electrically conductive paths, such as the switches and electrically conductive paths that make up buses, bridges, physical input/output ports, and the like. Types of signal communication paths are used, such as fiber optic communication paths and/or wireless communication paths.

The volatile memory 118 is any type of volatile memory now known or to be developed in the future. Examples include dynamic type random access memory RAM or static type RAM. Typically, the volatile memory 118 is characterized by a random access, but this is not needed unless affirmatively indicated. In the computer 102, the volatile memory 118 is located in a single package and is internal to the computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 is a read-only memory ROM, but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the container generation module 120B typically includes at least some of the computer code involved in performing the disclosed methods.

The peripheral device set 122 includes the set of peripheral devices of computer 102. Data communication connections between the peripheral devices and the components of computer 102 may be implemented in various ways, such as Bluetooth connections, Near-Field Communication NFC connections, connections made by cables such as universal serial bus USB type cables, insertion-type connections for example, secure digital SD card, connections made through local area communication networks and even connections made through wide area networks such as the internet. In various embodiments of the disclosure, the UI device set 122A includes components such as a display screen, speaker, microphone, wearable devices such as goggles and smartwatches, keyboard, mouse, printer, touchpad, game controllers, and haptic devices. The storage 122B is external storage, such as an external hard drive, or insertable storage, such as an SD card. The storage 122B is persistent and/or volatile. In some embodiments of the disclosure, storage 122B may take the form of a quantum computing storage device for storing data in the form of qubits. In embodiments of the disclosure where computer 102 is needed to have a large amount of storage for example, where computer 102 locally stores and manages a large database then this storage may be provided by peripheral storage devices designed for storing very large amounts of data, such as a storage area network SAN that is shared by multiple, geographically distributed computers. The IoT sensor set 122C is made up of sensors that may be used in Internet of Things applications. For example, a first sensor may be a thermometer, and a second sensor may be a motion detector.

The network module 124 is the collection of computer software, hardware, and firmware that allows computer 102 to communicate with the computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure, for example, embodiments that utilize software-defined networking SDN, the control functions and the forwarding functions of the network module 124 are performed on physically separate devices, such that the control functions manage several different network hardware devices. Computer-readable program instructions for performing the disclosed methods may typically be downloaded to computer 102 from an external computer or external storage device through a network adapter card or network interface included in the network module 124.

The WAN 104 is any wide area network, for example, the internet for communicating computer data over non-local distances by any technology for communicating computer data, now known or to be developed in the future. In some embodiments of the disclosure, the WAN 104 may be replaced and/or supplemented by local area networks LANs designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user, for example, a customer of an enterprise that operates computer 102 and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 may display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machines that collect and store helpful and useful data for use by computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provide on-demand availability of computer system resources and/or the computer capabilities, especially data storage cloud storage, and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments VCEs typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments VCEs will now be provided. VCEs may be stored as “images”. A new active instance of the VCE may be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system may utilize resources of that computer, such as connected devices, files and folders, network shares, CPU power, and quantifiable hardware capabilities. However, programs running inside a container may only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of different types, for example, private, community, or public cloud types, often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

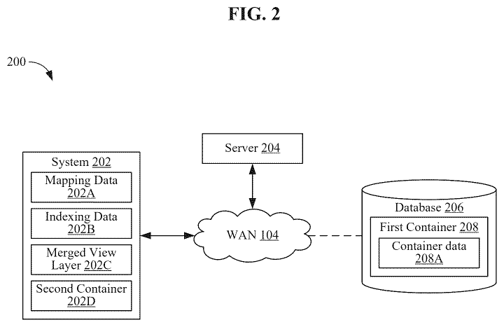

FIG. 2 is a diagram that illustrates a network environment for the generation of a second container 202D based on container data 208A of a first container 208, in accordance with an embodiment of the disclosure. FIG. 2 is explained in conjunction with elements from FIG. 1. With reference to FIG. 2, there is shown a diagram of a network environment 200. The network environment 200 includes a computer system 202 (referred to as a system 202, hereinafter). The network environment 200 further includes a server 204 and a database 206. The database 206 is configured to store a first container 208 and container data 208A associated with the first container 208. The network environment 200 further includes the WAN 104 of FIG. 1. In an example, the system 202 is an exemplary embodiment of the computer 102 in FIG. 1.

The system 202 may include suitable logic, circuitry, interfaces, and/or code that may be configured to receive container data 208A associated with the first container 208. The first container 208 includes one or more layers. Each layer of the one or more layers stores one or more compressed files. The system 202 is further configured to generate mapping data 202A associated with each layer of the one or more layers based on the container data 208A. The mapping data 202A indicates one or more mappings and each mapping of the one or more mappings maps file path data for a compressed file of the one or more compressed files to file data associated with the compressed file of the one or more compressed files. The system 202 is further configured to generate indexing data 202B based on the mapping data 202A. The indexing data 202B indicates an index of the mapping data 202A of each layer of the one or more layers into a merged view layer 202C. The system 202 is further configured to generate a second container 202D based on the indexing data 202B. The second container 202D includes at least one image associated with each layer of the one or more layers and the merged view layer 202C. The second container 202D is different from the first container 208. In particular, the second container 202D is a new container that is generated based on the first container 208. For example, the first container 208 and the second container 202D may be associated with a same application. However, the first container 208 may be used in a first deployment environment whereas the second container 202D may be used in a second deployment environment. In an example, the application is a security application. In such a case, the first deployment environment may be associated with a first enterprise whereas the second deployment environment may be associated with a second enterprise. The system 202 is further configured to output the second container 202D.

A container may correspond to a lightweight, portable unit of software that encapsulates an application and its dependencies, allowing it to run consistently across different environments such as a development environment, a testing environment, a staging environment, different deployment environments, and the like. Further, a pod may enable tightly coupled containers to run together in an isolated environment, providing communication and resource sharing among the containers. For example, a pod may include a web server container running on Engine X (nginx) to manage hypertext transfer protocol (HTTP) requests from clients. Additionally, the pod may include a database container running My Structured Query Language (MySQL), which stores and retrieves data from a web application. Since both the web server and database are housed within the same pod, they may share the same network namespace, allowing them to communicate directly using “localhost”. This setup enables fast data retrieval and storage without the latency associated with inter-pod communication.

The server 204 may include suitable logic, circuitry, interfaces, and/or code that may be configured to host the system 202. Upon receiving the first input data, the server 204 may be further configured to store the container data. The server 204 may be implemented as a cloud server and may execute processes through web applications, cloud applications, HTTP requests, repository operations, file transfer, and the like. Additional example implementations of the server 204 may include, but are not limited to, a database server, a file server, a web server, a media server, an application server, a mainframe server, or a cloud computing server.

In an embodiment of the disclosure, the server 204 may be implemented as a plurality of distributed cloud-based resources by use of several technologies that are well known to those ordinarily skilled in the art. A person with ordinary skill in the art will understand that the scope of the disclosure may not be limited to the implementation of the server 204 and the system 202 as two separate entities. In certain embodiments, the functionalities of the server 204 can be incorporated in its entirety or at least partially in the system 202, without a departure from the scope of the disclosure.

The database 206 may include an organized collection of container images that may be stored and accessed electronically by a computer system, such as the system 202. In an embodiment, the database 206 may be an image repository. Thus, the database 206 may correspond to a centralized storage system where the containers are stored, i.e., the first container 208 is stored, managed, and distributed. The database 206 may allow developers such as the user to upload, store, and pull the container (i.e., the first container 208). In an embodiment, the database 206 may correspond to a public image repository or a private image repository. The public image repository may host publicly available images. For example, a default image may be retrieved for lightweight web servers. The private image repository may include an organization-specific registry that may store proprietary images. For example, an internal repository may store sensitive container images used in confidential applications and may be accessible through authenticated devices.

In an embodiment, the system 202 may be a software framework that enables the deployment, management, and scaling of containerized applications. The system 202 provides a consistent runtime environment by encapsulating the containerized application and its dependencies within the containers, ensuring seamless processes across various computing environments. Further, the system 202 may offer tools and services for orchestrating containers, optimizing resource utilization, and automating tasks such as scaling and fault tolerance. Examples of different types of the system 202 include container engines such as docker, container orchestrators, and the like.

In operation, the system 202 is configured to receive the container data 208A associated with the first container 208. By way of example, and not by limitation, the container data 208A includes information to define and operate the first container 208. The container data 208A includes metadata, configuration files, and the actual content of the first container 208, which ensures that an application associated with the first container 208 runs correctly in one or more environments. The metadata is used for tracking changes, managing updates, and ensuring compatibility with components in the system 202. Further, the configuration files included in the container data 208A specify the settings and parameters that dictate how the application within the first container 208 should operate. These configurations can include environment variables, resource limits, and network settings. Moreover, the actual content of the first container 208, which consists of the application code and its dependencies, is packaged alongside the metadata and configuration files.

Moreover, the first container 208 includes one or more layers, and each layer of the one or more layers stores one or more compressed files. The first container 208 is structured as one or more layers, each of the one or more layers is designed to enhance modularity and efficiency in application deployment. The one or more layers allow for the separation of different components and functionalities. Each layer of the one or more layers may store one or more compressed files, which may include application code, libraries, dependencies, and configuration settings.

Additionally, the use of the one or more compressed files stored in the one or more layers optimizes storage and bandwidth usage. By compressing files, the first container 208 may minimize the amount of data that needs to be transferred during deployment or updates, which is particularly beneficial in environments with limited resources or bandwidth constraints.

The system 202 is further configured to generate mapping data associated with each layer of the one or more layers based on the container data 208A. The mapping data indicates one or more mappings. Each mapping of the one or more mappings maps file path data for each compressed file of the one or more compressed files to file data associated with a corresponding compressed file of the one or more compressed files. In an example, the system 202 is configured to generate the mapping data for each layer within the one or more layers of the first container 208. The mapping data for each layer is generated by utilizing the container data 208A. The mapping data 202A serves as a guide that shows how each compressed file is linked to its specific location and content. For example, imagine the first container 208 with two compressed files: one for an application called “app.tar.gz” and a library called “lib.tar.gz”. The mapping data may include entries like: “File Path 1: /app/app.tar.gz”, and “File Data 1: main.py and utils.py”, “File Path: /lib/lib.tar.gz”, and “File Data 2: NumPy and pandas”. In this way, the mapping data 202A connects the file paths (where the files are located) to the actual content of those files. The mapping data 202A serves as a structured representation that links or maps specific locations of files within the first container 208 to the actual content of the corresponding files.

The mapping data for each layer provides a clear association between the file path of a compressed file within the first container and the file data of the compressed file. The file path may include, for example, an address or a location of the file within the first container. This ensures that when an application requests a specific file, the system 202 may quickly locate and access the file data associated with the specific file without delays.

In an example, the system 202 generates the mapping data 202A that establishes relationships between the file paths of one or more compressed files stored in the one or more layers and the corresponding file data associated with those files. The mapping data 202A is utilized in the container runtime to access and manage the files within each layer of the one or more layers. For example, the first container 208 includes a layer 1, a layer 2, and the layer 3. The layer 1 includes a first compressed file named app.tar.gz, which includes the application code, while the layer 2 includes a second compressed file named lib.tar.gz, which includes libraries. The layer 3 includes configuration files. The system generates mapping data 202A for these layers, where the mapping for the layer 1 indicates that the file path /app/app.tar.gz corresponds to the actual application code files, such as main.py and utils.py. Similarly, the mapping for the layer 2 shows that the file path /lib/lib.tar.gz corresponds to the libraries needed by the application. The mapping of the layer 3 shows that the file path config/config.json corresponds to the actual configuration files. This mapping data 202A allows the container runtime to efficiently locate and retrieve the files when the application is executed. For instance, when the application needs to run main.py, the system 202 can quickly refer to the mapping data to find the compressed file app.tar.gz, decompress it, and access the needed code.

The system 202 is configured to generate indexing data 202B based on the mapping data 202A. The indexing data 202B indicates an index of the mapping data 202A of each layer of the one or more layers into the merged view layer 202C. The indexing data 202B serves as an organizational tool that provides a structured overview of the mapping data 202A associated with each layer of the one or more layers within the first container 208. By consolidating the mapping information into a unified format, the indexing data 202B provides efficient access and management of the files contained within the one or more layers.

The indexing data 202B indicates how the mapping data 202A from each layer of the one or more layers is organized into a merged view layer 202C. The merged view layer 202C acts as a comprehensive reference point, allowing the system 202 to quickly locate and retrieve files based on the file paths and corresponding file data. By indexing the mapping data 202A, the system 202 enhances its ability to manage file dependencies and relationships, ensuring that files are readily accessible when needed. This structured approach to indexing is particularly beneficial in environments where multiple containers may share common layers. The indexing data 202B allows for duplication.

Furthermore, the indexing data 202B may be utilized to streamline processes such as updates and modifications. When changes are made to a specific layer of the one or more layers, the indexing data 202B may quickly identify which files are affected, allowing for targeted updates without the need to rebuild the entire container.

In an example, the system 202 generates the indexing data 202B based on the mapping data 202A, which creates the index of the mappings for each layer of the one or more layers of the first container 208 into a consolidated view as the merged view layer 202C. This indexing process is used to retrieve and manage the one or more compressed files within the first container 208, as it enables the system 202 to quickly access relevant mappings without the need to sift through each layer individually. For instance, consider the first container 208 includes three layers. The layer 1 includes an application code, the layer 2 includes libraries, and the layer 3 holds configuration files. The mapping data 202A for these layers might specify that the layer 1 has a file path /app/app.tar.gz linked to files like main.py, the layer 2 has /lib/lib.tar.gz linked to libraries such as NumPy, the layer 3 has /config/config.json linked to configuration settings. The system generates a structured index that consolidates these mappings into a single view, allowing the container runtime to efficiently access entire files across each of the one or more layers by referencing this single index.

The system 202 is configured to generate a second container 202D based on the indexing data 202B. The second container 202D includes at least one image associated with each layer of the one or more layers and the merged view layer 202C. The second container 202D is different from the first container 208. Based on the indexing data 202B, the system 202 may generate the second container 202D, ensuring that the second container 202D contains the components for the application to function correctly. The inclusion of images associated with each layer of the one or more layers allows the second container 202D to maintain the modularity and flexibility inherent in container technology. Each image of the one or more images represents a specific state or version of the application, enabling easy updates and rollbacks as needed. The process of generating a second container includes the indexing data 202B derived from the first container 208 to create a new, distinct container tailored to specific computing needs. The second container 202D includes at least one image associated with each layer of the first container 208, and the merged view layer 202C consolidates the mappings of each of one or more corresponding files within the one or more layers. The second container 202D is designed to be different from the first container 208, allowing for modifications or enhancements that cater to particular requirements, such as optimizing performance, adding new features, or adjusting configurations. For example, if the first container 208 is used for a web application, the second container 202D might be generated to include additional monitoring tools or updated libraries that enhance functionality or security. By leveraging the indexing data 202B, the system 202 may efficiently reference the components from the one or more layers of the first container 208 while ensuring that the second container 202D meets the evolving demands of the computing environment.

The merged view layer 202C consolidates the mapping data 202A from each layer of the one or more layers into a single, coherent structure. The merged view layer 202C provides quick access to the files and the corresponding file data needed by the application. By organizing the file data in this manner, the merged view layer allows the system 202 to quickly locate and retrieve the files and their corresponding data. This structured approach reduces the time and computational resources needed to access files, as the system 202 can reference a unified index rather than searching through multiple layers individually. The system 202 is configured to output the second container 202D. In an embodiment, the system 202 outputs the second container 202D. This output process involves finalizing the assembly of the second container 202D, ensuring that the second container 202D is fully equipped with components including the images associated with each layer of the one or more layers and the merged view layer 202C. The output signifies that the second container 202D is ready for deployment and may be utilized in various operational environments. Once the second container 202D is generated, the second container 202D undergoes a series of checks to verify its integrity and functionality. This may include validating the contents of the second container 202D, ensuring that needed files are present and correctly linked, and confirming that the second container 202D adheres to certain specifications. These checks are vital for maintaining the reliability of the containerized application. After successful validation, the system 202 outputs the second container 202D, making the second container 202D available for use. This output may take various forms, such as storing the second container 202D in a designated container registry, where the second container 202D may be accessed by developers and deployment systems, or directly deploying the second container 202D to a target environment for immediate use.

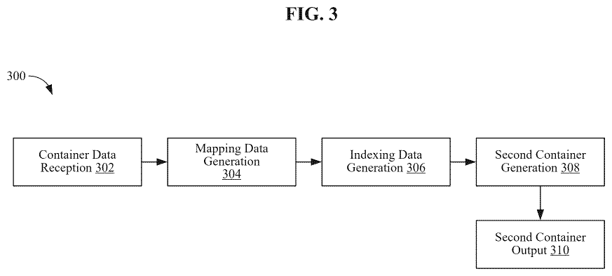

FIG. 3 is a diagram 300 that illustrates one or more operations performed by the system 202 for the generation of the second container 202D based on the container data 208A of the first container 208, in accordance with an embodiment of the disclosure. FIG. 3 is explained in conjunction with elements from FIG. 1, and FIG. 2. With reference to FIG. 3, the operation may start at 302.

At 302, a container data reception operation is executed. In the container data reception operation, the system 202 is configured to receive the container data 208A associated with the first container 208. The first container 208 includes one or more layers. Each layer of the one or more layers stores one or more compressed files. The first container 208 may be a software package that includes an application and associated dependencies, organized into one or more layers. The one or more layers are typically read-only, e.g., once a layer is created, it cannot be modified. Each layer of the first container 208 stores one or more compressed files, which contain the actual file data for the application to function. The one or more compressed files may include the application code, libraries, configuration files, and resources to run the application. Moreover, each layer can represent specific changes or additions made to the application or its dependencies. For example, the base layer might contain the core operating system files, while subsequent layers could include updates to the application code or the addition of new libraries.

In an embodiment, the container data 208A includes at least one of layer data associated with each layer of the one or more layers, file metadata associated with each compressed file of the one or more compressed files of each layer of the one or more layers, or file data associated with each compressed file of the one or more compressed files. The layer data provides a detailed representation of an architecture of the first container 208, capturing specific changes or additions made at each layer of the one or more layers. The layer data includes information such as, but not limited to, dependencies between the one or more layers, unique identifiers associated with each layer of the one or more layers, and structural details associated with each layer of the one or more layers. The structural details may indicate for example, but are not limited to, a hierarchy among the one or more layers, a size associated with the one or more compressed files of each of the one or more layers, and a type associated with the one or more compressed files of each of the one or more layers.

Further, the file metadata associated with each compressed file within the one or more layers provides information about the compressed files, such as file name, file size, timestamps, and any attributes needed for file organization and management. By associating the file metadata with the corresponding compressed file, the system 202 enables seamless access to the file content data during container operations.

Further, the file content data associated with each compressed file within the one or more layers includes binary information stored in a specific compressed file. In an example, the file content data associated with a specific file of the one or more compressed files of a particular layer may include, but is not limited to, file header, data segments, and checksums. The file header provides structural information about the specific file, such as, but not limited to, file format and organization. The data segments include content or a payload stored in the specific file, which may include application code, configuration details, or any vital resources. The checksums ensure the integrity and authenticity of the file content data, verifying that the file content data is not altered during storage or transmission. The file content data is vital for reconstructing and utilizing the specific compressed files during runtime, ensuring that the applications have access to accurate and complete information. By retaining the file content in a compressed format, the system 202 optimizes storage space while providing mechanisms for retrieving and processing the data when needed.

In an embodiment, the container data 208A may include references associated with a first set of container images, i.e., image names, repository uniform resource locator (URL), tags, and the like associated with the first container 208. For example, the user may specify container images such as nginx: v1.2 and database: v3.1 along with their respective configurations, i.e., resource limits, environment variables, or ports to expose. The container data 208A may further include a desired startup order, i.e., a first sequence associated with the first container 208. For example, the container data 208A may define that the first container 208 may start before the web server container. Based on the container data 208A, the electronic device may be configured to generate a modification request associated with the first container 208. The electronic device may be further configured to provide the modification request to the system 202.

At 304, a mapping data generation operation is executed. In the mapping data generation operation, the system 202 is configured to generate the mapping data 202A associated with each layer of the one or more layers based on the container data 208A. The mapping data 202A includes the one or more mappings that establish a relationship between the file paths of each compressed file within the one or more layers and the corresponding file data associated with the files. Each mapping links a specific file path, such as /app/app.tar.gz, to its actual content, which may include application code, libraries, or configuration settings.

By way of example, and not by limitation, the mapping data 202A for each layer of the one or more layers in the first container 208 results in a structured representation of relationships between the file paths and the corresponding file data of the compressed files stored within the layers of the one or more layers. The mapping data 202A acts as an intermediary structure linking the hierarchical organization of the one or more compressed files within the first container 208 to the file content data and associated file metadata. This ensures file retrieval, access, and management during runtime or subsequent processes such as indexing and merging. In an example, the mapping data is associated with a particular compressed file of the one or more compressed files of a layer. In such a case, the mapping data 202A includes file paths that act like addresses, showing where each specific compressed file is located within the first container 208. The file data includes information such as file headers, which provide details about the file, the actual binary content of the file, and checksums, which are used to verify that the data has not been corrupted or changed. The mapping data establishes the relationship between the file path of the compressed file and the associated file data of the compressed file, allowing the system 202 to locate and access the compressed file without decompressing the entire layer in which the compressed file is stored.

In an example, the system 202 is configured to parse the container data 208A to identify the compressed file of the one or more compressed files. Thereafter, the system 202 is configured to generate a key-value structure for the compressed file. This key-value structure may include a key indicative of a file path of the compressed file in the corresponding layer, while the value is indicative of file data of the compressed file. In this manner, the mapping data is generated for the compressed file. Similarly, the mapping data 202A is generated for each compressed file of the one or more compressed files of each layer of the one or more layers. Thereafter, the mapping data 202A is stored, for example, in a memory or a database associated with the system 202. The mapping data 202A may be stored in a format optimized for quick lookups and updates. The mapping data 202A precomputes relationships avoids redundant operations during runtime, and supports scalable handling of complex container structures while ensuring integrity.

By way of example, and not by limitation, the first container 208 includes one or more layers. These one or more layers may include a first layer, a second layer, and a third layer. Each layer of the first layer, the second layer, and the third layer may store different files. It may be noted that some file(s) of the second layer may be associated with or may overlap with some file(s) of the first layer. For instance, the first layer includes version 1 of a configuration file having a file path as, for example, ‘/app/config/settings.json/l1’ The second layer includes version 1 of an error log file having a file path as, for example, ‘/app/logs/error.log/l2’, as well as version 2 of the configuration file having the file path as ‘/app/config/settings.json/l2’. Further, the third layer includes version 1 of a text file having a file path as, for example, ‘/app/readme.txt/l3’ without altering files from the second layer or the first layer.

During the mapping data generation operation, the system 202 analyzes each layer of the one or more layers to extract file paths and associated file data. For instance, the mapping data 202A associated with the first layer may include a mapping between the file path ‘/app/config/settings.json/l1’ of the configuration file to file content data, such as binary data, header offset, and length of the configuration file. When processing the second layer, the system 202 generates a mapping between the file path ‘/app/logs/error.log/l2’ and file content data associated with the error log file, and mapping between the file path ‘/app/config/settings.json/l2’ and updated file content data of updated configuration file. To this end, the mapping data for the configuration file is updated to the new file path in the second layer to reflect version 2, overriding the earlier entry from the first layer. Further, for the third layer, the mapping data includes a mapping between the file path ‘/app/readme.txt/l3’ and the file content data of the text file. The mapping data for each layer of the first layer, the second layer, and the third layer may be combined to form the mapping data 202A.

The resulting mapping data 202A represents a consolidated view across each of the one or more layers, with the most recent versions of overlapping files taking precedence. This unified structure enables efficient file retrieval during runtime. For example, when the system 202 needs to access the configuration file, the system 202 directly retrieves the mapping of the configuration file from the mapping data 202A, pointing to the latest version stored in the second layer, without scanning or decompressing the first container 208.

In an embodiment, a specific layer of the one or more layers includes the one or more compressed files. The mapping data 202A associated with the specific layer includes the one or more mappings. Each mapping of the one or more mappings is associated with a corresponding compressed file of the one or more compressed files. By way of example, and not by limitation, the specific layer among the one or more layers includes both the compressed files and the associated mapping data. The mapping data 202A for the specific layer is composed of one or more mappings for the one or more compressed files of the specific layer. Each of the one or more mappings establishes a direct relationship between the file path and the corresponding file data. For instance, if the specific layer contains two compressed files, app.tar.gz, and lib.tar.gz, the mapping data 202A may include entries that clearly define the relationship between these files and their locations within the first container 208. Each mapping would specify the file path for the compressed file and provide details about the file data contained within it.

In an embodiment, a specific compressed file of the one or more compressed files of the specific layer is associated with a specific mapping of the one or more mappings. The specific mapping includes a key indicating the file path data associated with the specific compressed file in the specific layer and a value indicating the file data associated with the specific compressed file. By way of example, and not by limitation, the specific compressed file within the specific layer of the first container 208 is linked to a unique mapping that provides data retrieval and management. This mapping includes a key-value pair, where the key corresponds to the file path data associated with the specific compressed file, effectively serving as an identifier for locating the specific compressed file within the specific layer. The value indicates the file data associated with the specific compressed file, which may include information such as the file's binary content, headers, and metadata. This allows the system 202 to quickly access the file data without decompressing the entire specific layer, thereby optimizing performance and reducing overhead during the runtime process. By maintaining this association between file paths and their corresponding data, the system 202 ensures that file management processes are streamlined, enabling updates, retrievals, and modifications in a time and resource-efficient manner.

In an example, the mapping data generated for the specific layer includes entries such as but not limited to, a first mapping or a first key-value pair and a second mapping or a second key-value pair. A first key of the first mapping may indicate the file path data as, for example, ‘/app/config/db.json, while a first value of the first mapping may indicate the file data as, for example, ‘[compressed file data 1, header offset 1, data length 1]’. Further, a second key of the second mapping may indicate the file path data as, for example, ‘/app/logs/system.log’ and a second value of the second mapping may indicate the file data as, for example, [compressed file data 2, header offset 2, data length 2]’. Each of the one or more compressed files in the specific layer is uniquely associated with a mapping that ensures the file path is directly linked to the respective file data.

In an embodiment, the file data of the specific compressed file includes at least one of a file name, content data, file header data, file header offset in the specific compressed file, or data length information associated with the specific compressed file in a corresponding layer of the one or more layers. By way of example, and not by limitation, the file name indicates a unique identifier for the specific compressed file from the one or more compressed files. The file name may include, for example, a base name, i.e., a primary name of the specific compressed file, and an extension indicative of a format of the specific compressed file. Further, the content data may represent actual information stored within the specific compressed file. The file header data provides structural information, such as the format and organization of the specific compressed file. Furthermore, the file header offset indicates the precise location of a header within the specific compressed file, which is vital for accurate data retrieval. Moreover, the data length information indicates the size of the content data within the specific compressed file.

At 306, an indexing data generation operation is executed. In the indexing data generation operation, the system 202 is configured to generate the indexing data 202B based on the mapping data 202A. The indexing data 202B indicates an index of the mapping data 202A of each layer of the one or more layers into a merged view layer 202C. In an example, the indexing data 202B consolidates the mapping data 202A from each layer of the one or more layers into the merged view layer 202C.

By way of example, and not by limitation, the indexing data generation operation transforms layer-specific mappings into a cohesive structure that represents a logical aggregation of the mapping data 202A. This transformation ensures that overlapping or dependent layers are integrated consistently and accurately. For example, if layer 2 modifies a file present in Layer 1, the indexing data 202B prioritizes the updates from the layer 2, ensuring that the most recent version is reflected in the merged view layer 202C. This conflict resolution mechanism enhances data consistency and reliability. During this operation, the system 202 parses the mapping data 202A to identify file paths and dependencies, resolves any overlaps by applying a hierarchical priority system, and constructs the merged view layer 202C.

In an embodiment, the system 202 is configured to determine dependency data associated with the one or more layers. By way of example, and not by limitation, the system 202 is configured to identify and analyze the dependencies associated with each layer of the one or more layers in the first container 208. In an embodiment, the dependency is the relationships between files, configurations, or resources within or across the one or more layers for proper operation.

The system 202 analyzes the mapping data 202A and the file metadata associated with each layer of the one or more layers to identify dependency information. For example, if the second layer relies on libraries or configuration files present in the first layer, the system 202 is configured to determine whether these dependencies are recorded and categorized. The system 202 uses indexing and mapping techniques to pinpoint specific files or resources that are used for the functioning of dependent layers. This information is structured into a dependency graph or table for efficient access. In one embodiment, determining the dependency data is needed for resolving conflicts and ensuring that changes in one layer do not adversely affect one or more layers. For instance, if an updated file in the third layer requires a specific version of a library in the first layer, the system 202 flags this dependency to ensure compatibility.

The merged view layer acts as a unified access point, enabling seamless retrieval and management of data across the one or more layers. By consolidating the mapping data 202A, the indexing operation reduces redundancy and minimizes the need to process individual layers during runtime. This process also supports scalability, allowing the system 202 to manage containers with numerous layers and extensive file mappings.

In an embodiment, the merged view layer 202C provides a seamless access point for each compressed file of the one or more compressed files and file metadata within the first container 208. In an example, when two or more layers include a specific file path but different versions or modifications thereof, the merged view layer 202C may provide a mapping between file path data from a topmost layer of the one or more layers with corresponding file data in the topmost layer indicative of a most recent version of the specific compressed file. However, if there is a need to revert to an older version of the file, a rollback process must be initiated. This process involves identifying the specific layer that includes the desired previous version of the specific compressed file. The system 202 utilizes the mapping data 202A to locate the appropriate file path in that older layer. Once identified, the system 202 extracts the specific compressed file content from the specified layer and replaces or restores it in the current working environment. This may also involve updating the merged view layer 202C to reflect the changes, ensuring that the application now points to the older version of the specific compressed file. The merged view layer 202C aggregates the mapping data 202A of each layer of the one or more layers into a single, logical structure. This aggregation ensures that the overall file system associated with the first container 208 is represented comprehensively without duplication or fragmentation. By way of example, and not by limitation, by consolidating mapping data 202A, the merged view layer 202C eliminates the need to individually access or scan each of the one or more layers during runtime. This optimization reduces overhead and improves performance for file retrieval and updates.

At 308, a second container generation operation is executed. In the second container generation operation, the system 202 is configured to generate the second container 202D based on the indexing data 202B. The second container 202D includes at least one image associated with each layer of the one or more layers of the first container 208. The second container 202D also includes the merged view layer 202C. The second container 202D is different from the first container 208. For instance, the second container 202D includes a writable layer in addition to multiple read-only layers. These read-only layers may correspond to the at least one image associated with the one or more layers of the first container 208, i.e., the one or more layers inherited from the first container 208. Each file within the one or more layers is stored in a compressed format, and any modifications to the files are made exclusively in the writable layer of the second container 202D. The writable layer allows users to make changes without altering the original layers, maintaining the integrity of the base container data, i.e., the container data 208A.

In an embodiment, the system 202 is configured to utilize the merged view layer 202C for the generation of the second container 202D. By referencing the indexing data 202B and the mapping data 202A, the system 202 is configured to identify and organize the one or more compressed files for inclusion in the second container 202D.

By way of example, the writable layer in the second container 202D provides a dynamic environment where frequent modifications are performed. Changes made to files are stored in a separate layer of the image on the top of one or more layers, leaving the original compressed files in the base layers untouched. This preserves the integrity of the first container 208 and supports version control and rollback processes. Furthermore, the use of compressed files for storage optimizes disk space and improves performance during file retrieval. By copying files from the specific layers as needed, the system 202 ensures that the second container 202D remains scalable and handles complex and resource-intensive applications.

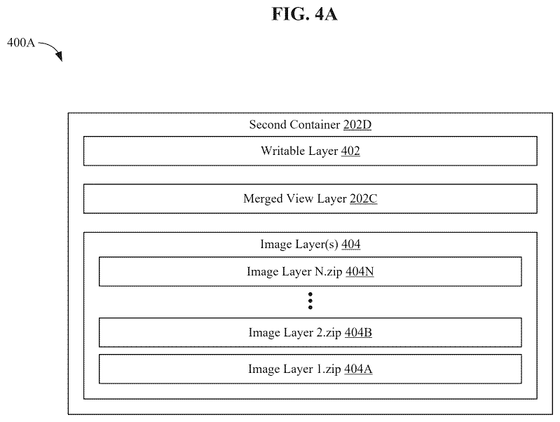

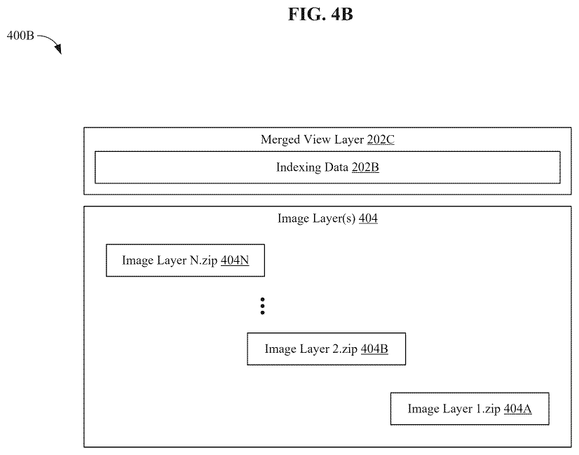

Details associated with the second container 202D are described in conjunction with, for example, FIG. 4A and FIG. 4B.

At 310, a second container output operation is executed. In the second container output operation, the system 202 is configured to output the second container. In an example, the second container 202D is output to be utilized in various ways depending on the operational context and requirements. For instance, the system 202 may output the second container 202D directly to a user computing environment for deployment in an application, making it immediately available for runtime operations.

By way of example, and not by limitation, the system 202 is configured to store the second container 202D in a database. This allows version control, provides distribution across multiple environments, and allows for backups in case of failure or rollback scenarios. For instance, in a cloud-based container registry, the second container 202D can be securely stored and made accessible to multiple developers or systems, enabling collaborative workflows. Similarly, in edge computing applications, the second container 202D can be transferred to lightweight devices for localized processing, ensuring minimal latency and efficient operation.

The system 202 leverages the merged view layer 202C to ensure that the second container 202D is fully optimized before output. By referencing the indexing data 202B in the merged view layer 202C, the system 202 verifies that the one or more compressed files are correctly linked and accessible. For example, a container containing a web application could be output to a deployment server where it is launched as a microservice or stored in a versioned repository to maintain a history of updates.

FIG. 4A is a diagram 400A that illustrates a schematic diagram of the second container 202D, in accordance with an embodiment of the disclosure. The second container 202D includes a plurality of layers. The plurality of layers may include a writable layer 402, the merged view layer 202C, and image layer(s) 404. FIG. 4A is explained in conjunction with elements from FIG. 1, FIG. 2, and FIG. 3.

The image layer(s) 404 may include one or more image layers. The image layer(s) 404 are stored in compressed format, for example, in ‘.zip’ format. The image layer(s) 404 may include an image layer 1.zip 404A, and an image layer 2.zip 404B, up to an image layer N.zip 404N.

In an embodiment, the writable layer 402 is configured to handle the write operation performed during the container runtime. The writable layer 402 in the second container 202D allows the user to make modifications to any one of the one or more compressed files of the one or more layers without altering the underlying read-only image layers (i.e., the image layer(s) 404 associated with each of the one or more layers). Changes such as file creation, updates, and deletion are stored exclusively in the writable layer 402. In one embodiment, the writable layer 402 allows the user to modify files in the second container 202D without making any alterations to the underlying read-only image layers i.e., the image layer(s) 404. For instance, developers or users may create and manage the second container 202D that is tailored to specific applications or services, with the ability to update or modify compressed files from a specific image layer of the image layer(s) 404 without affecting the second container 202D. This maintains the integrity of the image layer(s) 404 while still providing the flexibility needed for dynamic operations. Any changes made during the execution of the second container 202D such as the creation of new files, updates to existing files, or deletions are exclusively stored within the writable layer 402. This ensures that the image layer(s) 404 remains intact and unaltered, providing a stable foundation for the operation of the second container 202D.

In an embodiment, the merged view layer 202C acts as an abstracted unified view that includes the indexing of the image layer(s) 404 into a single, cohesive file system. The merged view layer 202C ensures access to the one or more compressed files and directories in the image layer(s) 404 by utilizing the indexing data 202B that organizes and maps the relationship between the file paths and their corresponding content. The writable layer 402 is overlaid on top of the immutable layers (i.e., the image layer(s) 404). The merged view layer 202C provides the second container 202D with a combined filesystem representation, hiding the complexity of the layered architecture from the user.

In an embodiment, the image layer(s) 404 are immutable, read-only layers that include the base files and directories needed to run the second container 202D. Each image layer of the image layer(s) 404 is stored in a compressed archived format, i.e., zip, to reduce storage size and improve retrieval efficiency.

The use of compressed image layers reduces the overall size of the second container 202D, making it easier to transfer and deploy across different environments. This is particularly beneficial in cloud-based scenarios where bandwidth and storage costs can be a concern. Further, the use of the compressed image layer(s) 404 enhances retrieval efficiency, as smaller files can be loaded more quickly into memory, leading to faster startup times for the second container 202D. This is vital in modern application development, where rapid deployment and scalability are often key requirements.

Moreover, the architecture of the second container 202D, with its distinct layers, allows for a high degree of modularity and flexibility. Developers can create and manage the second container 202D that is tailored to specific applications or services, with the ability to update or modify compressed files from the specific image layer of the image layer(s) 404 without affecting the second container 202D. This modularity is particularly advantageous in microservices architectures, where applications are composed of multiple, independently deployable services. In an example, each application can be encapsulated within the second container 202D, utilizing shared image layer(s) while maintaining the writable layer 402 for runtime modifications.

In an embodiment, the layered architecture of the second container 202D enhances security. By isolating the writable layer 402 from the immutable image layer (i.e., the image layer(s) 404), the system 202 reduces the risk of unintended changes to the base environment. This isolation ensures that any vulnerabilities or issues that arise during the container's operation are contained within the writable layer 402, preventing them from affecting the underlying image layer(s) 404. Consequently, this design promotes a more secure and stable environment for running applications. Further, details associated with the image layer(s) 404 is described in conjunction with, for example, FIG. 4B.

Furthermore, the merged view layer 202C plays a critical role in managing the interactions between the writable layer 402 and the image layer(s) 404. The merged view layer 202C acts as a mediator, ensuring that any read operations are directed at the appropriate layer based on the availability of files. If a file exists in the writable layer 402, the merged view layer 202C will provide access to that version; if it does not, the system 202 is configured to reference the corresponding file in the image layer(s) 404. This management of compressed files enhances operations of the second container 202D by reducing the need for file lookups.

FIG. 4B is a diagram 400B that illustrates a schematic diagram of the plurality of layers of the second container 202D, in accordance with an embodiment of the disclosure. The plurality of layers includes the merged view layer 202C and the image layer(s) 404. FIG. 4B is explained in conjunction with elements from FIG. 1, FIG. 2, FIG. 3, and FIG. 4A.

In an embodiment, the system 202 is configured to generate the mapping data 202A for each layer of the one or more layers associated with the first container 208. Each layer of the one or more layers stores one or more compressed files. Further, the system 202 is configured to generate the second container 202D based on the first container 208. In this regard, each layer of the one or more layers corresponds to a specific image layer of the image layer(s) 404.

In an embodiment, the image layer 1.zip 404A may correspond to a first layer of the one or more layers of the first container 208. For example, the first layer may store a first compressed file. The system 202 is configured to generate first mapping data associated with the first layer of the one or more layers of the first container 208. The first mapping data may include a first key indicating first file path data associated with the first compressed file in the first layer and a first value indicating file data associated with the first compressed file.

Similarly, the image layer 2.zip 404B may correspond to a second layer of the one or more layers of the first container 208. For example, the second layer may store a second compressed file. The system 202 is configured to generate second mapping data associated with the second layer of the one or more layers of the first container 208. The second mapping data may include a second key indicating first file path data associated with the second compressed file in the second layer and a second value indicating file data associated with the second compressed file. Similarly, the system 202 is configured to generate Nth mapping data associated with an Nth layer of the one or more layers of the first container 208. The Nth layer of the one or more layers may correspond to the image layer N.zip 404N.

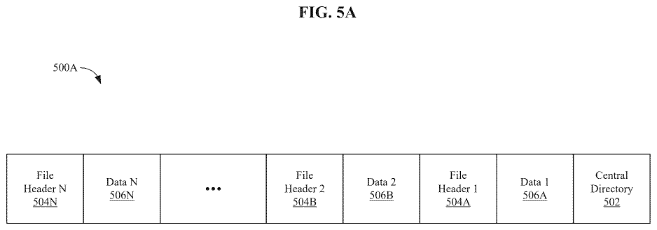

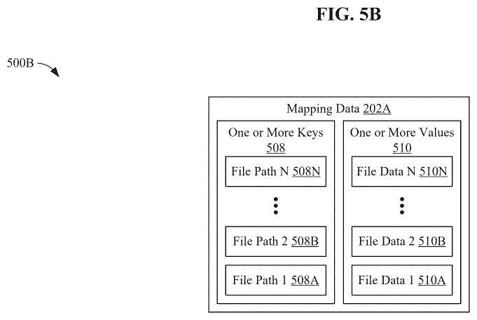

Although the present example describes each layer of the one or more layers to store a single compressed file, this should not be considered as a limitation. In various embodiments, each layer of the one or more layers may store a plurality of compressed files. In such a case, mapping data for each layer of the one or more layers may include plurality of key-value pairs. Further, the mapping data for each layer of the one or more layers of the first container 208 is referred to as the mapping data 202A. Details associated with the structure and generation of the mapping data are described in conjunction with, for example, FIG. 5A and FIG. 5B.

In an embodiment, the system 202 is configured to merge one or more values associated with the one or more mappings for the specific layer. The one or more values are merged based on one or more keys associated with the one or more mappings being associated with the specific layer. The one or more values are inclusive of the value of the specific compressed file and the one or more keys are inclusive of the key of the specific compressed file. In an example, the system 202 merges one or more values associated with the mappings for a specific layer. The one or more values that are merged include the value corresponding to the specific compressed file, which includes the file data such as the file's content, metadata, and relevant attributes.

In an example, the mapping data for a specific layer includes one or more mappings. Each of these mappings is associated with a file from one or more compressed files stored in the specific layer. A particular mapping for a particular compressed file of the specific layer may include a key indicating file path data for the particular compressed file and a value indicating file data of the particular compressed file. In this manner, multiple mappings for the specific layer are generated when the specific layer includes multiple compressed files stored therein. To this end, the system 202 is configured to merge values of mappings based on the keys of the mappings. In particular, as the keys of the mappings for the multiple compressed files of the specific layer may indicate a file path pointing to the specific layer, the values of these mappings for the multiple compressed files of the specific layer are merged. By merging values based on the one or more keys, the system 202 effectively consolidates information.

Further, the system 202 is configured to generate the indexing data 202B based on the mapping data 202A. In particular, the system 202 is configured to generate the indexing data 202B based on the first mapping data of the first layer, the second mapping data of the second layer, to the Nth mapping data of the Nth layer. In an example, an index of a specific layer of the one or more layers is utilized for creating a structured way to access the values, e.g., the file data, of the specific layer associated with the first container 208. By leveraging the merged mapping data 202A, the system 202 generates a coherent index that reflects relationships between file paths and their corresponding values, enhancing the overall organization of the file system.

In an example, the system 202 is configured to generate the indexing data 202B by analyzing the merged values and associated keys to create a quick reference point for each compressed file within the specific layer. This indexing data 202B serves as a lookup table, enabling rapid retrieval of file data without the need to traverse through the entire mapping data.

Further, the system 202 is configured to generate the merged view layer 202C based on the indexing data. This process involves synthesizing the indexed mapping data to generate a unified representation of the compressed files and their associated information in the specific layer to be added to the second container 202D. The merged view layer 202C provides a coherent structure that reflects the most current state of the compressed files, including any updates or modifications made in the specific layer. The merged view layer 202C may indicate a layer in which a most recent version of a particular file is stored. In order to retrieve the particular compressed file, an index of the particular compressed file may be identified from the indexing data 202B. The index may indicate a specific image layer of the image layer(s) 404 in which the particular compressed file is stored. Thereafter, the system 202 may parse the mapping data associated with a layer in which the particular compressed file is stored to identify an offset length, a length of the file, etc. Based on the determined data, the system 202 is configured to retrieve the particular compressed file from the specific image layer.

FIG. 5A is a diagram 500A that illustrates a schematic diagram of a data structure associated with mapping data of a specific layer, in accordance with an embodiment of the disclosure. The data structure includes a central directory 502 associated with mapping data of the specific layer. In addition, the data structure includes a file entry of each compressed file of the one or more compressed files stored in the specific layer. In an example, the one or more compressed files of the specific layer are mapped into a key-value structure. Such key-value structure may correspond to the mapping data for the specific layer. In particular, by following the data structure, the one or more compressed files in the specific layer are mapped into the key-value structure of the mapping data. FIG. 5A is explained in conjunction with elements from FIG. 1, FIG. 2, FIG. 3, FIG. 4A, and FIG. 4B.

In an embodiment, each compressed file of the one or more compressed files of the specific layer are stored in ‘.Zip’ format as a separate file entry. The file entry of a specific compressed file may include actual data of the specific compressed file and a local header that includes information about the specific compressed file.

In an example, the file entry for the specific layer of the one or more layers of the first container 208 includes data 1 506A and file header 1 504A corresponding to a first file entry. The first file entry is associated with a first compressed file of the one or more compressed files of the specific layer. Similarly, the file entry for the specific layer may include data 2 and a file header 2 504B corresponding to a second file entry. The second file entry is associated with a second compressed file. In this manner, the file entry may include up to data N 506N and a file header N 504N corresponding to an Nth file entry for an Nth compressed file.

To provide access to the one or more compressed files, each file entry includes the file header, e.g., the file header 1 504A, the file header 2 504B, up to the file header N 504N (collectively referred to as file headers 504, hereinafter). The file headers 504 provide specific information about the corresponding compressed file of the one or more compressed files of the specific layer. The specific information may include, but is not limited to, name, size, a method used for compression, and a relative offset. The relative offset indicates a position of the file entry, measured from the beginning of the data structure of the specific layer. This allows the system 202 to quickly locate a file entry for a specific compressed file without having to search through the entire mapping data of the specific layer.

In an embodiment, a central directory 502 acts as a comprehensive index for each of the one or more compressed files contained within the specific layer. The central directory 502 is a table that lists each file's name, size, and relative offset, making it easier for programs to manage and access the one or more compressed files of the specific layer. When the mapping data is generated, the data structure, e.g., the central directory 502 and the file entry, are populated with entries for each file of the one or more compressed files. In an example, the central directory 502 can be accessed quickly to find the information about any compressed file from the one or more compressed files in the mapping data.

In an embodiment, when the system 202 has to access a specific file within the mapping data, the system 202 utilizes the central directory 502 to identify a relative offset of the file entry corresponding to the specific compressed file. Further, the system 202 is configured to retrieve the specific compressed file based on the file entry corresponding to the specific compressed file. Once the system 202 has the relative offset, the system 202 navigates directly to the corresponding file entry, by passing the need to scan through the entire mapping data. Details associated with a structure of the mapping data of the specific layer is described in conjunction with FIG. 5B.

FIG. 5B is a diagram 500B that illustrates a schematic diagram of the mapping data 202A associated with a specific layer, in accordance with an embodiment of the disclosure. In an example, the mapping data 202A is generated in the form of a key-value structure. To this end, the mapping data 202A includes one or more keys 508 and one or more values 510. FIG. 5B is explained in conjunction with elements from FIG. 1, FIG. 2, FIG. 3, FIG. 4A, FIG. 4B, and FIG. 5A.

In an embodiment, the one or more keys 508 include a series of file paths, specifically a file path 1 508A, a file path 2 508B, extending up to a file path N 508N. Each of the file paths serves as an address pointing to corresponding compressed file of the one or more compressed files stored within the specific layer of the first container 208. By utilizing the file paths, the system 202 easily locates and retrieves a compressed file, ensuring that users can access their data without delays or complications.

The one or more values 510 complements the one or more keys 508 by including actual file data associated with each of the one or more compressed files. The one or more values 510 include file data 1 510A corresponding to the file path 1 508A, file data 2 510B corresponding to the file path 2 508B, extended up to file data N 510N corresponding to the file path N 508N, which represents contents of the one or more compressed files identified by the respective keys. The relationship between the one or more keys 508 and the one or more values 510 is fundamental to the structure of the mapping data 202A, as it allows for a straightforward association between the location of the compressed files and their corresponding data. When a request is made to access a specific compressed file, the system 202 first utilizes the mapping data 202A to identify an appropriate key, which leads to the retrieval of the associated value containing the file data of the specific compressed file.

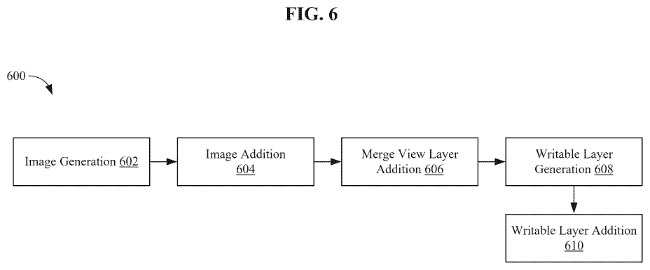

FIG. 6 is a diagram 600 that illustrates one or more operations performed by the system 202 for addition of a file to the writable layer 402 of the second container 202D, in accordance with an embodiment of the disclosure. FIG. 6 is explained in conjunction with elements from FIG. 1, FIG. 2, FIG. 3, FIG. 4A, FIG. 4B, FIG. 5A and FIG. 5B. With reference to FIG. 6, the operations may start at 602.

At 602, an image generation operation is executed. In the image generation operation, the system 202 is configured to generate at least one image for each layer of the one or more layers. The at least one image for a layer of the one or more layers indicates an image layer for one or more compressed files stored in the layer. The image corresponds to the compressed files and associated file metadata for the corresponding layers of the one or more layers. Each image includes the specific changes, configurations, and dependencies encapsulated within the corresponding layer. By way of example, and not by limitation, the first container 208 includes one or more layers. The one or more layers include a first layer that may correspond to, for i.e., the image layer 1.zip 404A which includes foundational system files, such as, but not limited to, an operating system. Further, the one or more layers include a second layer that may correspond to, for i.e., the image layer 2.zip 404B which includes application-specific components, at the file location at “/app/config/settings.json”. Further, the one or more layers include an Nth layer that may correspond to, for i.e., the image layer N.zip 404N which includes logs or documentation at file location at “/app/logs/error.log” and “/app/readme.txt”. The images are further stored in a compressed format, optimizing disk usage, and ensuring efficient access during runtime.

For instance, the image for the first layer may include dependencies shared by each of the one or more layers, providing a stable foundation for higher layers. Similarly, the image for the second layer includes the application-specific configurations. Further, the image for the Nth layer includes a log and non-vital files. This allows the system 202 to reuse and update the specific layers without impacting the second container 202D.

At 604, an image addition operation is performed. In the image addition operation, the system 202 is configured to add the at least one image for each layer of the one or more layers to the second container 202D. In an example, the system 202 adds the image(s) generated for each layer to the second container 202D. These images represent the compressed files and metadata corresponding to their respective layers. The addition of images ensures that the entire layer-specific data is integrated into the second container 202D in a manner that preserves modularity and provides scalability.

For instance, the images generated for the first layer at the file path, the second layer, and the Nth layer are added sequentially to the second container 202D. Further, the system 202 ensures that each image is correctly placed according to its hierarchical position within the first container 208. The first layer corresponds to the base layer, providing the foundational system files. The second layer builds upon this, adding application-specific configurations, while the Nth layer adds useful files like logs and documentation.

In an embodiment, the system 202 ensures that the file content associated with each layer of the one or more layers remains independent yet interconnected, enabling the system 202 to handle updates or modifications without affecting unrelated layers of the one or more layers or the one or more image layers.

At 606, a merged view layer addition operation is performed. In the merged view layer addition operation, the system 202 is configured to add the merged view layer 202C to the second container 202D. The merged view layer 202C is arranged above the at least one image for each layer of the one or more layers. In an example, the system 202 includes the merged view layer 202C into the second container 202D on top of the image layer(s) 404 corresponding to the one or more layers of the first container 208. The merged view layer 202C acts as an integrative structure that consolidates the mapping data 202A and provides a unified perspective of the content of the image layer(s) 404 of the second container 202D.

For instance, after adding the images for the first layer, the second layer, and the third layer, the system 202 incorporates the merged view layer 202C which consolidates the indexing data 202B from each of the one or more layers, resolving conflicts and creating a single, unified file system.

In an embodiment, by positioning the merged view layer 202C above the at least one image of the one or more layers, the system 202 creates a logical hierarchy that supports file retrieval and runtime performance. The merged view layer 202C acts as the primary interface for accessing files, while the underlying images provide the foundational data.

At 608, a writable layer generation operation is performed. In the writable layer generation operation, the system 202 is configured to generate the writable layer 402 for the second container 202D. For example, the system 202 executes the writable layer generation operation, where it creates the writable layer 402 for the second container 202D. This writable layer 402 is a critical addition that enables dynamic modifications during runtime without altering the underlying read-only layers.

In an embodiment, the writable layer 402 is utilized for frequent updates or temporary changes, such as, but not limited to, application debugging, session data storage, or log generation. The writable layer 402 provides a dedicated space for capturing modifications while preserving the integrity of the second container 202D (i.e., the image layer(s) 404). This provides rollback operations, as changes can be discarded by clearing the writable layer 402 without impacting the original data in the image layer(s) 404.

At 610, a writable layer addition operation is performed. In the writable layer addition operation, the system 202 is configured to add the writable layer 402 to the second container 202D. The writable layer 402 is arranged above the merged view layer 202C. In an example, the system 202 adds the writable layer into the second container 202D. The writable layer 402 is arranged above the merged view layer 202C, creating a structure that supports runtime modifications while maintaining the integrity of the underlying layers. This ensures a logical hierarchy within the second container 202D, allowing the writable layer 402 to capture changes without affecting the read-only base layers (i.e., the image layer(s) 404) or the merged view layer 202C.

By way of example, and not by limitation, the system 202 is configured to add the writable layer 402 as the topmost layer of the second container 202D.

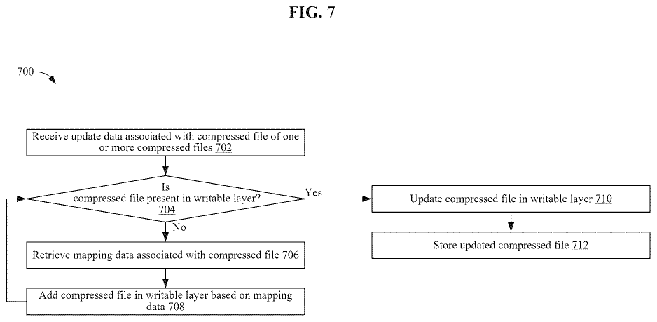

FIG. 7 is a diagram that illustrates a flowchart 700 of a method for updating a compressed file in the writable layer 402, in accordance with an embodiment of the disclosure. FIG. 7 is explained in conjunction with elements from FIG. 1, FIG. 2, FIG. 3, FIG. 4A, FIG. 4B, FIG. 5A, FIG. 5B and FIG. 6. With reference to FIG. 7, there is shown a flowchart 700. The operations of the exemplary method may be executed by any computing system, for example, by the computer 102 of FIG. 1 or the system 202 of FIG. 2. The operations of the flowchart 700 may start at 702.

At 702, update data associated with a compressed file of one or more compressed files is received. In an embodiment, the system 202 is configured to receive the update data associated with the compressed file of the one or more compressed files. In an example, the update data includes modifications to file content, file metadata, or configurations of the compressed file under consideration. Such an update may be applied to ensure that the second container 202D reflects the most up-to-date requirements of the application.

By way of example, and not by limitation, an application within the second container 202D requires an updated configuration file. For instance, a specific compressed file at file path “/app/config/settings.json” needs to include new parameters for database connectivity. The system 202 is configured to receive the update data for the compressed file, which may include the new connection strings and authentication credentials. For instance, the system 202 may receive the update data from the user, or the system 202 may update the compressed files of the one or more compressed files automatically.

In an embodiment, the system 202 is configured to receive the update data by establishing a secure and reliable communication channel to receive the update data. This may involve pulling updates from, but not limited to, a remote repository, the database 206, accepting direct input from the user, or integrating with continuous deployment pipelines. Further, the system 202 may verify for integrity and compatibility of the received update data. By doing so, the system 202 ensures that the update data aligns with the existing structure and does not introduce conflicts or errors to the second container 202D. For instance, the system 202 may validate the format of the new configuration parameters and confirm their consistency within the application.

This ensures that the second container 202D remains adaptable and responsive to changing requirements. By receiving and processing the update data in a structured manner, the system 202 provides a seamless update process that minimizes downtime and reduces the risk of errors.

At 704, a presence of the compressed file of the one or more compressed files in the writable layer is determined. In an embodiment, the system 202 is configured to determine the presence of the compressed file of the one or more compressed files in the writable layer 402. In an example, the system 202 is configured to determine whether a specific compressed file exists in the writable layer 402 of the second container 202D. This allows the system 202 to classify between modified and unmodified files, as the system 202 determines if the changes have already been directed to the writable layer 402 or if the base layer versions of the compressed file are being accessed.

In an embodiment, the system 202 analyzes the metadata associated with the writable layer 402. The system 202 utilizes the indexing data 202B and mapping data 202A to search for the compressed file in the writable layer 402. For instance, consider the compressed file at the file path “/app/config/settings.json”. If an application has modified this file during runtime, the system 202 checks whether the writable layer 402 contains a copy of this compressed file with the updated content. The system 202 examines metadata entries such as file paths, timestamps, and layer-specific identifiers to confirm the presence of the file in the writable layer 402.

By way of example, and not by limitation, an application running within the second container 202D generates runtime data, such as, but not limited to, updated logs or modified configuration settings. For instance, the system 202 is configured to check if this file already exists in the writable layer 402 before proceeding with additional updates. If the system 202 determines the presence of a file in the writable layer 402, the system 202 assumes that the file has been previously modified and proceeds to apply incremental updates. If the file is not present in the writable layer, the system identifies it as unmodified and pulls the base version of the file from the merged view layer or base layers to create a writable copy.

This presence determination process is efficient and minimizes resource overhead. For instance, in a multi-container deployment where multiple instances of the same container are running, the system 202 prevents redundant modifications by ensuring that only updates are stored in the writable layer 402. This approach also supports version control, as any changes directed to the writable layer 402 can be easily tracked and managed without impacting the original files in the image layer(s) 404.

In an embodiment, based on the determination at 704, if the system 202 determines the presence of the update data associated with the compressed file in the writable layer 402, the control may pass to 710.

In an embodiment, based on the determination at 704, if the system 202 determines the absence of the update data associated with the compressed file in the writable layer 402, the control may pass to 706.

At 706, mapping data 202A associated with the compressed file is retrieved. In an embodiment, the system 202 is configured to determine an absence of the compressed file of the one or more compressed files in the writable layer 402. Further, the system 202 is configured to retrieve the mapping data 202A associated with the compressed file. The mapping data 202A is retrieved from the merged view layer 202C. In an example, the system 202 retrieves the mapping data 202A associated with the specific compressed file from the merged view layer 202C. The mapping data 202A provides information about the compressed file, such as, but not limited to, the file location within the second container 202D, dependencies, associated metadata, file path, layer hierarchy, and any compression-related attributes for accessing and managing the specific compressed file.

By way of example, and not by limitation, an application requests access to the specific compressed file which may not be modified during runtime and thus is absent from the writable layer 402. The system 202 queries the merged view layer 202C to retrieve the mapping data 202A associated with the specific compressed file. For instance, the retrieved data indicates that the specific compressed file resides in a third layer, specifies the exact location within the layer, and includes any metadata for decompression.

At 708, the compressed file in the writable layer 402 based on the mapping data 202A is added. In an embodiment, the system 202 is configured to add the compressed file of the one or more compressed files in the writable layer 402 based on the mapping data 202A. In an example, the system 202 adds the compressed file to the writable layer 402 based on the retrieved mapping data 202A. This enables modifications or runtime updates to the specific corresponding files that were initially absent from the writable layer 402. The mapping data 202A retrieved from the merged view layer 202C acts as the guiding reference for locating, extracting, and adding the compressed file to the writable layer 402.

In an embodiment, the system 202 is configured to retrieve file content associated with the compressed file based on the file data associated with the compressed file. In an example, the system 202 extracts the actual content of the compressed file using the file data associated with the compressed files. This includes retrieving binary or textual content associated with the file data. Further, the system 202 is configured to add the file content to the writable layer 402. In an example, after retrieving the file content, the system 202 adds the file content into the writable layer 402. This ensures that the compressed file is accessible for modifications and runtime operations. This allows preservation of the integrity of the image layer(s) 404 while providing flexibility for runtime changes. By adding the compressed file to the writable layer 402, the system 202 creates a separate, modifiable copy that does not affect the original file stored in the image layer(s) 404. This allows the system 202 to roll back and version control mechanisms, as any changes made to the writable layer 402 can be discarded without altering the original data. For example, if an application needs to modify /app/config/settings.json for runtime use, the system 202 first adds the file to the writable layer 402 based on the mapping data 202A. The application then updates the file in the writable layer 402, ensuring that the image layer version remains unchanged. Further, once the file is added to the writable layer 402, the operations may move to 704.

At 710, the compressed file in the writable layer 402 is updated. In an embodiment, the system 202 is configured to update the compressed file of the one or more compressed files in the writable layer. The compressed file is updated based on the update data. In an example, the system 202 modifies the compressed file located in the writable layer 402 based on the received update data. When the system 202 receives update data, the system 202 identifies the corresponding file in the writable layer 402 using the file path and associated metadata. For instance, suppose an application update/app/config/settings.json to include new parameters for a feature toggle. The system 202 locates the writable layer 402 version of the corresponding file and applies the changes specified in the update data. This may involve modifying existing entries or appending new content, such as additional configuration keys and values.

By way of example, and not by limitation, the update data ensures compatibility with the existing file structure. For example, if the update data includes JSON content, the system 202 validates the syntax and structure before applying the changes. Any discrepancies or errors in the update data are flagged to maintain the container's stability. After processing, the system 202 applies the update directly to the writable layer 402, ensuring that subsequent file access reflects the most recent changes. For example, if the system 202 receives the update data to add a new log entry to/app/logs/error.log, the system 202 locates the file in the writable layer 402, validates the update data, and appends the new entry. This process ensures that the log file reflects the most current information without affecting the original file stored in the image layer(s) 404.

At 712, updated compressed files are stored. In an embodiment, the system 202 is configured to store the updated compressed file. In an example, the system 202 stores the updated compressed file. When an updated compressed file, such as/app/config/settings.json, is ready for storage, the system 202 first generates a new layer to house this update. This new layer acts as an extension of the writable layer 402 and ensures that the updated file does not overwrite the original file in the base layers.

The process begins by compressing the updated file if it was modified in its decompressed form. For example, if/app/logs/error.log was updated with new entries during runtime, the system 202 compresses the file using the specified algorithm to ensure consistency with the container's format. The compressed file is then stored in the newly created layer, along with metadata that records the file path, modification timestamp, and relevant attributes. This metadata is utilized for managing dependencies and ensuring that the updated file can be accessed efficiently.

By creating a new layer for storing updated files, the system 202 maintains the modular structure of the second container 202D. Each layer serves a specific purpose, whether it holds base files, runtime modifications, or updates. This layered architecture simplifies container management and enhances scalability. For instance, if a new version of /app/config/settings.json is released, the system 202 can add it to a new layer, keeping the previous versions intact for reference or rollback.

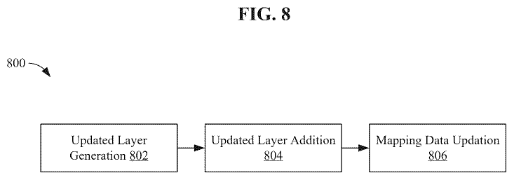

FIG. 8 is a diagram 800 that illustrates one or more operations performed by the system 202 for updation of mapping data 202A associated with the second container 202D, in accordance with an embodiment of the disclosure. FIG. 8 is explained in conjunction with elements from FIG. 1, FIG. 2, FIG. 3, FIG. 4A, FIG. 4B, FIG. 5A, FIG. 5B, FIG. 6, and FIG. 7. The one or more operations may be executed by any computing system, for example, by the computer 102 of FIG. 1 or the system 202 of FIG. 2. The operations may start at 802.

At 802, an updated layer generation operation is executed. In the updated layer generation operation, the system 202 is configured to generate an updated layer for the second container. The updated layer is generated based on the updated compressed file. In an example, the updated layer is generated based on the updated compressed file and serves as a modular extension of the second container 202D, maintaining the integrity of the existing layers while incorporating the new changes.

When a compressed file, such as/app/config/settings.json, is updated during runtime, the system 202 includes the modification within a distinct updated layer. This layer isolates the changes from the image layer(s) 404, ensuring that the updates do not overwrite or interfere with the foundational data. By generating an updated layer. The system 202 analyzes the updated compressed file to ensure that the system 202 adheres to the container's format and specifications. This includes compressing the file and attaching metadata that records details such as the file path, modification timestamp, and the layer hierarchy. For example, if /app/logs/error.log is updated with new entries, the system 202 compresses the file and includes this information in the updated layer. The updated layer is then integrated into the second container 202D as a new layer and positioned above the image layer(s) 404 in the hierarchy. This arrangement ensures that the updated file takes precedence during file retrieval operations while preserving the integrity of the image layers(s) 404. For instance, if an application accesses/app/config/settings.json, the system 202 retrieves the updated version from the new layer, ensuring that the application operates with the most current data.

At 804 an updated layer addition operation is executed. In the updated layer addition operation, the system 202 is configured to add the updated layer to the second container 202D. The updated layer is added below the merged view layer 202C. In an example, the system 202 adds the newly generated updated layer into the second container 202D and maintains the hierarchical structure of the second container 202D while ensuring that the updates remain accessible and organized.

By way of example, and not by limitation, by placing the updated layer below the merged view layer 202C, the system 202 ensures that it does not disrupt the unified access provided by the merged view layer 202C. Instead, the updated layer acts as a direct source for the modified files, while the merged view layer 202C consolidates one or more layers for seamless file retrieval. For example, if the updated layer includes a new version of /app/config/settings.json, this file will be available to applications accessing the merged view layer 202C without affecting the original file in the image layer(s) 404.

At 806, a mapping data updation operation is executed. In the mapping data updation operation, the system 202 is configured to update the mapping data associated with the corresponding file based on the update of the compressed file and the addition of the updated layer to the second container 202D. In an example, the system 202 updates the mapping data 202A associated with a corresponding file. This operation ensures that the mapping data 202A reflects the most current state of the second container 202D.

When an updated compressed file, such as/app/config/settings.json, is added to the updated layer, the system 202 updates the mapping data 202A to include the new layer as the source of the file. This update prioritizes the most recent version of the file while preserving references to the original versions stored in the base layers.

For example, if the updated layer contains a modified version of/app/logs/error.log, the system 202 updates the mapping data 202A to reflect that this file now resides in the updated layer. This revised mapping ensures that any application requesting/app/logs/error.log retrieves the latest version from the updated layer instead of an outdated version from a lower layer.

The updation of the mapping data 202A includes recalibrating file paths, layer hierarchies, and metadata to ensure consistency across the second container 202D. In particular, when a change is made to a particular file of a first layer, an updated version of the particular file may be saved in a different layer, for example, a fourth layer. In such a case, the system 202 is configured to recalibrate a file path for the particular file from the first layer to the fourth layer. Subsequently, the metadata of the particular file may also change. To this end, the system 202 is configured to continually monitor and update the mapping data 202A and/or the indexing data 202B in the merged view layer 202C. This is particularly vital in environments with frequent updates, as it prevents conflicts and redundancy while maintaining seamless access to files.

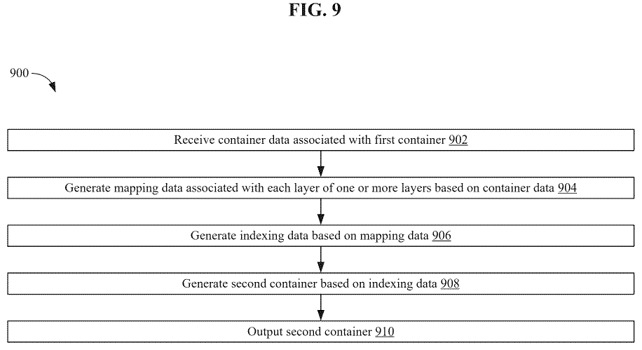

FIG. 9 is a diagram that illustrates a flowchart 900 of an exemplary method for the generation of the second container based on the indexing data, in accordance with an embodiment of the disclosure. FIG. 9 is explained in conjunction with elements from FIG. 1, FIG. 2, FIG. 3, FIG. 4A, FIG. 4B, FIG. 5A, FIG. 5B, FIG. 6, FIG. 7, and FIG. 8. With reference to FIG. 9, there is shown the flowchart 900. The operations of the exemplary method may be executed by any computing system, for example, by the computer 102 of FIG. 1 or the system 202 of FIG. 2. The operations of the flowchart 900 may start at 902.

At 902, the container data 208A associated with the first container 208 is received. In an embodiment, the system 202 is configured to receive the container data 208A associated with the first container 208. The first container 208 includes one or more layers. Each layer of the one or more layers stores one or more compressed files.

At 904, the mapping data associated with each layer of the one or more layers based on the container data is generated. In an embodiment, the system 202 is configured to generate the mapping data 202A associated with each layer of the one or more layers based on the container data 208A. The mapping data 202A indicates one or more mappings and each mapping of the one or more mappings maps file path data for the compressed file of the one or more compressed files to file data associated with the compressed file of the one or more compressed files.

At 906, the indexing data 202B based on the mapping data 202A is generated. In an embodiment, the system 202 is configured to generate the indexing data 202B based on the mapping data 202A. The indexing data 202B indicates the index of the mapping data 202A of each layer of the one or more layers into the merged view layer 202C.

At 908, the second container 202D based on the indexing data 202B is generated. In an embodiment, the system 202 is configured to generate the second container 202D based on the indexing data 202B. The second container 202D includes at least one image associated with each layer of the one or more layers and the merged view layer 202C. The second container 202D is different from the first container 208.

At 910, the second container 202D is output. In an embodiment, the system 202 is configured to output the second container 202D. In an example, the system 202 stores the second container 202D to the database 206. In an embodiment, the system 202 is configured to render the second container 202D to the user device.

In various embodiments of the disclosure, a computer program product for the generation of the container based on the compressed files is described. The computer program product includes a computer-readable storage medium having program instructions stored on the computer-readable storage media to perform operations. The operations include receiving the container data 208A associated with the first container 208. The first container 208 includes one or more layers. Each layer of the one or more layers stores the one or more compressed files. The operations include generating the mapping data 202A associated with each layer of the one or more layers based on the container data 208A. The mapping data 202A indicates one or more mappings and each mapping of the one or mapping maps file path data for a compressed file of the one or more compressed files to file data associated with the compressed file of the one or more compressed files. The operation includes generating the indexing data 202B based on the mapping data 202A. The indexing data 202B indicates the index of the mapping data 202A of each layer of the one or more layers into a merged view layer 202C. The operation includes generating the second container 202D based on the indexing data 202B. The second container 202D includes at least one image associated with each layer of the one or more layers and the merged view layer 202C. The second container 202D is different from the first container 208. The operation includes outputting the second container 202D.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable a person with ordinary skill in the art to understand the embodiments disclosed herein.

1. A computer-implemented method, comprising:
receiving, by a computer, container data associated with a first container, wherein the first container comprises one or more layers, and wherein each layer of the one or more layers stores one or more compressed files;
generating, by the computer, mapping data associated with each layer of the one or more layers based on the container data, wherein
the mapping data indicates one or more mappings, and
each mapping of the one or more mappings maps file path data for a compressed file of the one or more compressed files to file data associated with the compressed file of the one or more compressed files;
generating, by the computer, indexing data based on the mapping data, wherein the indexing data indicates an index of the mapping data of each layer of the one or more layers into a merged view layer;
generating, by the computer, a second container based on the indexing data, wherein the second container is different from the first container, and the generating of the second container comprises:
generating, by the computer, at least one image for each layer of the one or more layers, wherein the at least one image indicates the one or more compressed files for a corresponding layer of the one or more layers;
adding, by the computer, the at least one image for each layer of the one or more layers to the second container;
adding, by the computer, the merged view layer to the second container, wherein the merged view layer is added above the at least one image for each layer of the one or more layers;
generating, by the computer, a writable layer for the second container; and
adding, by the computer, the writable layer to the second container, wherein the writable layer is added above the merged view layer; and
outputting, by the computer, the second container.

2. The computer-implemented method of claim 1, wherein the container data comprises at least one of layer data associated with each layer of the one or more layers, file metadata associated with each compressed file of the one or more compressed files of each layer of the one or more layers, or file content data associated with each compressed file of the one or more compressed files.

3. The computer-implemented method of claim 1, wherein a specific layer of the one or more layers comprises the one or more compressed files, and wherein
the mapping data associated with the specific layer comprises the one or more mappings, and
each mapping of the one or more mappings is associated with a corresponding compressed file of the one or more compressed files.

4. The computer-implemented method of claim 3, wherein a specific compressed file of the one or more compressed files of the specific layer is associated with a specific mapping of the one or more mappings, and wherein the specific mapping comprises a key indicating the file path data associated with the specific compressed file in the specific layer and a value indicating the file data associated with the specific compressed file.

5. The computer-implemented method of claim 4, wherein the file data of the specific compressed file comprises at least one of a file name, content data, file header data, file header offset in the specific compressed file, or data length information associated with the specific compressed file in a corresponding layer of the one or more layers.

6. The computer-implemented method of claim 4, further comprising:
merging, by the computer, one or more values associated with the one or more mappings for the specific layer, wherein
the one or more values are merged based on one or more keys associated with the one or more mappings being associated with the specific layer, and
the one or more values are inclusive of the value of the specific compressed file and the one or more keys are inclusive of the key of the specific compressed file;
generating, by the computer, the index of the mapping data for the specific layer based on the merging; and
generating, by the computer, the merged view layer based on the index of the mapping data for the specific layer.

7. (canceled)

8. The computer-implemented method of claim 1, further comprising:
receiving, by the computer, update data associated with a compressed file of the one or more compressed files;
determining, by the computer, a presence of the compressed file of the one or more compressed files in the writable layer; and
updating, by the computer, the compressed file in the writable layer based on the update data.

9. The computer-implemented method of claim 1, further comprising:
receiving, by the computer, update data associated with a compressed file of the one or more compressed files;
determining, by the computer, an absence of the compressed file of the one or more compressed files in the writable layer;
retrieving, by the computer, the mapping data associated with the compressed file from the merged view layer, wherein the mapping data is retrieved based on the determination of the absence;
adding, by the computer, the compressed file of the one or more compressed files in the writable layer based on the mapping data associated with the compressed file; and
updating, by the computer, the compressed file in the writable layer based on the addition of the compressed file in the writable layer, wherein the compressed file is updated based on the update data.

10. The computer-implemented method of claim 9, wherein the adding the compressed file of the one or more compressed files in the writable layer comprises:
retrieving, by the computer, file content associated with the compressed file based on the file data associated with the compressed file; and
adding, by the computer, the file content to the writable layer.

11. The computer-implemented method of claim 8, further comprising:
generating, by the computer, an updated layer for the second container, wherein the updated layer is generated based on the updated compressed file;
adding, by the computer, the updated layer to the second container, wherein the updated layer is added below the merged view layer; and
updating, by the computer, the mapping data associated with the compressed file based on the update of the compressed file and the addition of the updated layer to the second container.

12. The computer-implemented method of claim 1, further comprising:
parsing, by the computer, the mapping data associated with each layer of the one or more layers;
determining, by the computer, dependency data associated with the one or more layers based on the parsing of the mapping data; and
generating, by the computer, the indexing data based on the dependency data.

13. A computer system, comprising:
a processor set;
one or more computer-readable storage media; and
program instructions stored on the one or more computer-readable storage media, the program instructions executable by the processor set to cause the processor set to:
receive container data associated with a first container, wherein the first container comprises one or more layers, and wherein each layer of the one or more layers stores one or more compressed files;
generate mapping data associated with each layer of the one or more layers based on the container data, wherein
the mapping data indicates one or more mappings, and
each mapping of the one or more mappings comprises:
a key indicating file path data associated with a compressed file of the one or more compressed files, and
a value indicating file data associated with the compressed file of the one or more compressed files;
generate indexing data based on the mapping data, wherein the indexing data indicates an index of the mapping data of each layer of the one or more layers into a merged view layer;
generate a second container based on the indexing data, wherein the second container is different from the first container, and the generating of the second container comprises:
generate at least one image for each layer of the one or more layers, wherein the at least one image indicates the one or more compressed files for a corresponding layer of the one or more layers;
add the at least one image for each layer of the one or more layers to the second container;
add the merged view layer to the second container, wherein the merged view layer is added above the at least one image for each layer of the one or more layers;
generate a writable layer for the second container; and
add the writable layer to the second container, wherein the writable layer is added above the merged view layer; and
output the second container.

14. The computer system of claim 13, wherein the program instructions further cause the processor set to:
merge one or more values associated with the one or more mappings for a specific layer, wherein
the one or more values are merged based on one or more keys associated with the one or more mappings being associated with the specific layer, and
the one or more values are inclusive of the value and the one or more keys are inclusive of the key;
generate the index of the mapping data for the specific layer based on the merging; and
generate the merged view layer based on the index of the mapping data for the specific layer.

15. (canceled)

16. The computer system of claim 13, wherein the program instructions further cause the processor set to:
receive update data associated with a compressed file of the one or more compressed files;
determine a presence of the compressed file of the one or more compressed files in the writable layer; and
update the compressed file in the writable layer based on the update data.

17. The computer system of claim 13, wherein the program instructions further cause the processor set to:
receive update data associated with a compressed file of the one or more compressed files;
determine an absence of the compressed file of the one or more compressed files in the writable layer;
retrieve the mapping data associated with the compressed file from the merged view layer, wherein the mapping data is retrieved based on the determination of the absence;
add the compressed file of the one or more compressed files in the writable layer based on the mapping data associated with the compressed file; and
update the compressed file in the writable layer based on the addition of the compressed file in the writable layer, wherein the compressed file is updated based on the update data.

18. The computer system of claim 17, wherein to add the compressed file of the one or more compressed files in the writable layer the program instructions cause the processor set to:
retrieve file content associated with the compressed file based on the file data associated with the compressed file; and
add the file content to the writable layer.

19. The computer system of claim 16, wherein the program instructions further cause the processor set to:
generate an updated layer for the second container, wherein the updated layer is generated based on the updated compressed file;
add the updated layer to the second container, wherein the updated layer is added below the merged view layer; and
update the mapping data associated with the compressed file based on the update of the compressed file and the addition of the updated layer to the second container.

20. A computer program product for a generation of a second container based on one or more compressed files stored in a first container, the computer program product comprising:
one or more computer-readable storage media; and
program instructions stored on the one or more computer-readable storage media to perform operations comprising:
receiving container data associated with the first container, wherein the first container comprises one or more layers, and wherein each layer of the one or more layers stores the one or more compressed files;
generating mapping data associated with each layer of the one or more layers based on the container data, wherein
the mapping data indicates one or more mappings, and
each mapping of the one or more mapping maps file path data for a compressed file of the one or more compressed files to file data associated with the compressed file of the one or more compressed files;
generating indexing data based on the mapping data, wherein the indexing data indicates an index of the mapping data of each layer of the one or more layers into a merged view layer;
generating the second container based on the indexing data, and wherein the second container is different from the first container, and the generating of the second container comprises:
generating at least one image for each layer of the one or more layers, wherein the at least one image indicates the one or more compressed files for a corresponding layer of the one or more layers;
adding the at least one image for each layer of the one or more layers to the second container;
adding the merged view layer to the second container, wherein the merged view layer is added above the at least one image for each layer of the one or more layers;
generating a writable layer for the second container; and
adding the writable layer to the second container, wherein the writable layer is added above the merged view layer; and
outputting the second container.
